(19) United States
(12) Patent Application Publication
(10) Pub. No.: US 2024/0383235 A1
(43) Pub. Date: Nov. 21, 2024

(54) WINDSHIELD FOR VEHICLE AND MANUFACTURING METHOD THEREOF

(71) Applicant: AGC Inc., Tokyo (JP)

(72) Inventors: Naoki TESHIMA, Tokyo (JP); Yuukou MINAMIYA, Tokyo (JP)

(73) Assignee: AGC Inc., Tokyo (JP)

(21) Appl. No.: 18/786,351

(22) Filed: Jul. 26, 2024

Related U.S. Application Data
(63) Continuation-in-part of application No. PCT/JP2023/002011, filed on Jan. 24, 2023.

(30) Foreign Application Priority Data
Jan. 28, 2022 (JP) 2022-011383

(51) Int. Cl. B32B 17/10; B60J 1/00; B60J 1/02; H01R 4/02; H05B 3/84

(52) U.S. Cl. CPC B32B 17/10385; B32B 17/10036; B32B 17/1022; B32B 17/10348; B32B 17/10779; B32B 17/10807; B60J 1/001; B60J 1/02; H05B 3/84; B32B 2307/538; B32B 2605/00; B60J 1/002; H01R 4/02; H01R 2201/26

(57) ABSTRACT

A method for manufacturing a windshield for vehicle, the windshield for vehicle including a glass plate with a terminal, the method including: a step (S2) of applying a silver-containing paste containing silver and glass frit, which are materials of the conductor, onto the glass plate, which is a material of the glass plate with the terminal; a step (S3) of firing the glass plate coated with the materials of the conductor to form a conductor; a step (S5) of polishing a surface of a region including the terminal joint portion of the conductor; and a step (S6) of joining the terminal onto the terminal joint portion, a surface of which has been polished, with lead-free solder interposed therebetween, in which a porosity of the terminal joint portion of the conductor after step (S5) is 10% or less.

### INCORPORATION BY REFERENCE

This application claims priority based on Japanese Patent Application No. 2022-011383 filed on Jan. 28, 2022, and PCT application No. PCT/JP2023/002011 filed on Jan. 24, 2023, the disclosure of which is incorporated herein in its entirety by reference.

### BACKGROUND

The present disclosure relates to a windshield for vehicle and a manufacturing method thereof.

A laminated glass in which a plurality of glass plates are bonded together or a tempered glass is suitably used for a window glass for vehicle such as an automotive. Typically, a glass plate used as a material for a windshield for vehicle has a light-shielding layer formed in its peripheral region, and is processed into a shape having a curved surface by thermoforming.

A windshield for vehicle is known that includes: a conductor that includes an electric function portion or is connected to an electric function portion; and feeding members such as a harness and a cable. Examples of the electric function portion include an electric heating wire, an electric heating layer, an antenna, a light control layer, a light emitting element, and combinations thereof.

For example, in a windshield, an electric heating wire or an electric heating layer may be formed at the lower end portion and side end portion of the windshield in order to melt frost, snow, ice, etc. adhering to the wipers and to prevent the wipers from freezing.

Additionally, on the inner surface of the windshield, optical apparatuses may be installed that include optical devices such as ADAS (advanced driver assistance systems) cameras, LiDAR (light detection and ranging), a radar and optical sensors that acquire information in front of the vehicle, and a housing called a bracket etc. that houses these, for autonomous driving and collision accident prevention. In such a configuration, an electric heating wire or an electric heating layer may be formed on the glass portion in front of the optical devices to prevent fogging and frost, in order to improve the sensing accuracy by the optical apparatuses.

The conductor can be formed, for example, by coating and firing a silver-containing paste containing silver powder and glass frit. Firing of the silver-containing paste can be implemented simultaneously with thermoforming of the glass plate.

In this specification, a glass plate having a conductor is referred to as a “glass plate with a conductor.”

Conventionally, a conductor and a feeding member are joined using solder. The conductor may preferably include a feeding portion for feeding electricity to an electric function portion.

Conventionally, for example, a terminal is fixed to the head end portion of a feeding member such as a wire harness, and this terminal is joined to a conductor (preferably a feeding portion included in the conductor) using solder. There are two types of solder: leaded solder and lead-free solder. In recent years, there has been concern about the impacts of lead on the environment, and legal restrictions on leaded solder are becoming more widespread, so high-quality production techniques using lead-free solder are required.

In order to join the conductor and the solder sufficiently, it is necessary to form an alloy layer containing an alloy of one or more metal elements contained in the conductor and a plurality of metal elements contained in the solder at the joining interface between the conductor and the solder. To do this, it is necessary to heat the solder to its melting point or above.

When the above-mentioned solder joining is implemented on a glass plate with a conductor, the glass plate and solder are subjected to local high-temperature heating and temperature drop from high temperature to normal temperature. When the temperature drops, a difference in thermal expansion coefficient between the glass plate and the solder causes a difference in the amount of thermal contraction between the glass plate and the solder, and causes strain between the glass plate and the solder, causing stress (specifically, tensile stress) to be generated in the glass plate with the conductor. The stress may remain after the temperature drop. This residual stress may cause cracks to occur in the glass plate with the conductor after manufacturing of the window glass.

Typically, the melting point of lead-free solder is higher than that of leaded solder, and is, for example, about 220° C., so it is necessary to implement solder joining at a higher temperature (for example, about 300° C.). Therefore, when lead-free solder is used, a larger thermal load is applied to the glass plate with the conductor in terms of temperature and time, and larger stress is generated. In addition, since lead-free solder does not contain lead, which has a low elastic modulus, it has a higher elastic modulus and is less likely to deform than leaded solder, so it is difficult to alleviate stress generated by temperature change. For these reasons, the problem of residual stress after joining and the resulting cracking after manufacturing can occur, especially when lead-free solder is used.

In Japanese Unexamined Patent Application Publication No. 2021-18932,
a glass plate module to which wire for supplying electric power can be joined, the glass plate module including:
a glass plate;
a heating wire placed on the glass plate; and
a feeding portion that is placed on the glass plate, is connected to the wire, and supplies electric power to the heating wire,
in which the feeding portion is formed of a conductive print, a main component of which is metal fine particles (preferably silver or copper fine particles) having a higher coefficient of thermal expansion than the glass plate, and
a thickness of the feeding portion is thinner than a thickness of the heating wire (claims 1 and 21).

The glass plate module can further include solder (preferably lead-free solder) placed on the feeding portion, and a terminal fixed to the feeding portion with the solder interposed therebetween (claims 23 and 25).

In Japanese Unexamined Patent Application Publication No. 2021-18932, the thickness of the feeding portion is made smaller than the heating wire, thereby reducing the tensile stress generated in the glass plate (paragraph 0108).

In Japanese Unexamined Patent Application Publication No. 2021-18932, the printing method of the conductive print is devised, and the thickness of the feeding portion is made smaller than that of the heating wire in the printing process of the conductive print (paragraphs 0117 and 0118).

International Patent Publication No. WO 2017/098164 discloses
glazing including an electrically conductive element, in which
the electrically conductive element includes a chromium-containing steel connector,
the connector is soldered to an electroconductive track by lead-free solder,
the electroconductive track is silver-based and has a resistivity of 3.5 μΩ·cm or less at 25° C. and a porosity of less than 20% (claim 1).

The electroconductive track is preferably a fritted silver-containing paste containing a mixture of silver powder and glass frit (claim 2).

International Patent Publication No. WO 2017/098164 states that “when the propagation of cracks in the electroconductive track should be limited, it is essential that the electroconductive track is not too porous, in other words, its porosity should be less than 20%”.

In the Example section of International Patent Publication No. WO 2017/098164, the porosity of the electroconductive track of Comparative Example 1 is 30%, the porosity of the electroconductive track of Example 2 is 16% and the porosity of the electroconductive track of Example 3 is 15%, and all of the porosities are 15% or more.

International Patent Publication No. WO 2017/098164 does not specifically describe a method for reducing porosity, and does not specifically describe an electroconductive track with a porosity of less than 15% and a method for realizing this.

If the breaking strength after terminal attachment is low, glass cracking may occur when external force is applied to the glass. Therefore, it is preferable that breaking strength after terminal attachment be high. Solder joint using lead-free solder preferably has a breaking strength after terminal attachment higher than the techniques described in Japanese Unexamined Patent Application Publication No. 2021-18932 and International Patent Publication No. WO 2017/098164.

In this description, “breaking strength after terminal attachment” means the load at which the loaded glass after terminal attachment breaks, and can be measured by a method described in the Examples section below.

The present disclosure has been made in view of the above circumstances, and an object thereof is to provide a method for manufacturing a windshield for vehicle, the method including a step of soldering a conductor and a terminal together using lead-free solder and being able to increase breaking strength after terminal attachment.

Another object of the present disclosure is to provide a windshield for vehicle that includes a portion where a conductor and a terminal are joined using lead-free solder and can have a higher breaking strength after terminal attachment.

### SUMMARY

The present disclosure provides the following windshield for vehicle and a manufacturing method thereof: [1] to [15].

[1] A method for manufacturing a windshield for vehicle, the windshield for vehicle including a laminated glass in which a plurality of glass plates are bonded together with an intermediate film interposed therebetween,
the laminated glass including a glass plate with a terminal, the glass plate with the terminal including a glass plate of the plurality of glass plates, a conductor, and the terminal, the conductor being formed on one surface of the glass plate, the conductor including a material containing silver and glass frit, the conductor having a terminal joint portion to which the terminal is joined, the terminal being joined onto the terminal joint portion of the conductor with lead-free solder interposed therebetween, the method comprising:
a step (S2) of applying a silver-containing paste containing silver and glass frit, which are materials of the conductor, onto the glass plate, which is a material of the glass plate with the terminal;
a step (S3) of firing the glass plate coated with the materials of the conductor to form the conductor including the terminal joint portion;
a step (S5) of polishing a surface of a region including the terminal joint portion of the conductor; and
a step (S6) of joining the terminal onto the terminal joint portion, a surface of which has been polished, with lead-free solder interposed therebetween,
in which a porosity of the terminal joint portion of the conductor after the step (S5) is 10% or less.

[2] The method for manufacturing a windshield for vehicle of [1], in which in the step (S2), a content of a vehicle in the silver-containing paste is 10 to 45% by mass.

[3] The method for manufacturing a windshield for vehicle of [1] or [2], in which in the step (S5), a rate of an arithmetic mean surface roughness of the terminal joint portion of the conductor after polishing with respect to that before polishing is 5 to 80%.

[4] The method for manufacturing a windshield for vehicle of any of [1] to [3], in which in the step (S5), a reduction rate of a film thickness of the terminal joint portion of the conductor after polishing with respect to that before polishing is 4 to 40%.

[5] The method for manufacturing a windshield for vehicle of any of [1] to [4], in which in the step (S5), a rate of Bi/Ag mass ratio of a surface of the terminal joint portion of the conductor after polishing with respect to that before polishing is 10 to 90%.

[6] The method for manufacturing a windshield for vehicle of any of [1] to [5], in which
in the laminated glass, the glass plate with the terminal includes an exposed portion not covered by the glass plate facing the glass plate with the terminal with the intermediate film interposed therebetween, the conductor is formed on a side of the intermediate film with respect to the glass plate with the terminal, and the terminal joint portion of the conductor is formed on the exposed portion of the glass plate with the terminal, and
the method includes, between the step (S3) and the step (S5), a step (S4) of bonding the plurality of glass plates with the intermediate film interposed therebetween.

[7] The method for manufacturing a windshield for vehicle of any of [1] to [5], in which
in the laminated glass, the conductor is formed on a side opposite to the intermediate film with respect to the glass plate with the terminal, and
the method includes, between the step (S3) and the step (S5), a step (S4) of bonding the plurality of glass plates with the intermediate film interposed therebetween.

[8] The method for manufacturing a windshield for vehicle of any of [1] to [7], in which
the glass plate with the terminal has a light-shielding layer between the glass plate and the terminal joint portion of the conductor,
the method includes, before the step (S2), a step (S1) of applying a ceramic paste containing a black pigment and glass frit, which are materials of the light-shielding layer, onto the glass plate, which is a material of the glass plate with the terminal, and
in step (S3), the materials of the light-shielding layer are fired to form the light-shielding layer.

[9] The method for manufacturing a windshield for vehicle of any of [1] to [8], in which
the conductor includes an electric function portion or is electrically connected to an electric function portion,
the conductor includes a feeding portion for feeding electricity to the electric function portion, and the feeding portion includes the terminal joint portion, and
a feeding member including a round-wire-shaped or foil-shaped conducting wire is fixed to the terminal.

[10] A windshield for vehicle comprising a laminated glass in which a plurality of glass plates are bonded together with an intermediate film interposed therebetween,
the laminated glass including a glass plate with a terminal, the glass plate with the terminal including a glass plate of the plurality of glass plates, a conductor, and the terminal, the conductor being formed on one surface of the glass plate, the conductor including a material containing silver and glass frit, the conductor having a terminal joint portion to which the terminal is joined, the terminal being joined onto the terminal joint portion of the conductor with lead-free solder interposed therebetween,
in which the conductor includes a polished surface in a region including the terminal joint portion, and includes a polished portion with a porosity of 10% or less.

[11] The windshield for vehicle of [10], in which
the conductor includes a non-polished portion that does not have a polished surface in a region that does not include the terminal joint portion, and
a rate of an arithmetic mean surface roughness of the polished portion with respect to that of the non-polished portion is 5 to 80%.

[12] The windshield for vehicle of [10] or [11], in which
the conductor includes a non-polished portion that does not have a polished surface in a region that does not include the terminal joint portion, and
a reduction rate of a film thickness of the polished portion with respect to that of the non-polished portion is 4 to 40%.

[13] The windshield for vehicle of any of [10] to [12], in which
the conductor includes a non-polished portion that does not have a polished surface in a region that does not include the terminal joint portion, and
a rate of a Bi/Ag mass ratio of a surface of the polished portion with respect to that of the non-polished portion is 10 to 90%.

[14] The windshield for vehicle of any of [10] to [13], in which
the glass plate with the terminal includes a light-shielding layer between the glass plate and the terminal joint portion of the conductor, and
the light-shielding layer contains a black pigment and glass frit.

[15] The windshield for vehicle of any of [10] to [14], in which
the conductor includes an electric function portion or is electrically connected to an electric function portion,
the conductor includes a feeding portion for feeding electricity to the electric function portion, and the feeding portion includes the terminal joint portion, and
a feeding member including a round-wire-shaped or foil-shaped conducting wire is fixed to the terminal.

The method for manufacturing a windshield for vehicle according to the present disclosure includes: a step (S5) of polishing the surface of the region including the terminal joint portion of the conductor; and a step (S6) of joining the terminal onto the terminal joint portion, the surface of which has been polished, with lead-free solder interposed therebetween. In this method, in the step (S5) (polishing step), it is possible to: reduce the porosity of the terminal joint portion of the conductor and the amount of components of the glass frit on the surface of the terminal joint portion of the conductor. This allows increase in the breaking strength after terminal attachment.

The present disclosure can also provide a windshield for vehicle that includes a portion where a conductor and a terminal are joined using lead-free solder and can have a higher breaking strength after terminal attachment.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an overall plan view of a windshield for vehicle according to a first embodiment of the present invention;

FIG. 2 is a partially enlarged plan view of FIG. 1;

FIG. 3 is a cross-sectional view taken along a line III-III in FIG. 2;

FIG. 4 is a partially enlarged cross-sectional view of FIG. 3;

FIG. 5A is a process diagram of a method for manufacturing a windshield for vehicle according to the first embodiment;

FIG. 5B is a process diagram of the method for manufacturing the windshield for vehicle according to the first embodiment;

FIG. 5C is a process diagram of the method for manufacturing the windshield for vehicle according to the first embodiment;

FIG. 5D is a process diagram of the method for manufacturing the windshield for vehicle according to the first embodiment;

FIG. 6 is a cross-sectional view showing an example of a design change of the first embodiment;

FIG. 7A is an overall plan view of a windshield for vehicle according to a second embodiment of the present invention;

FIG. 7B is a partially enlarged plan view of FIG. 7A;

FIG. 8 is a cross-sectional view taken along a line VIII-VIII in FIG. 7B;

FIG. 9A is a process diagram of a method for manufacturing a windshield for vehicle according to the second embodiment;

FIG. 9B is a process diagram of the method for manufacturing the windshield for vehicle according to the second embodiment;

FIG. 9C is a process diagram of the method for manufacturing the windshield for vehicle according to the second embodiment;

FIG. 10A are images each showing an example of measuring porosity of a conductor without polishing;

FIG. 10B are images each showing an example of measuring porosity of a conductor with polishing;

FIG. 10C are images each showing an example of measuring porosity of a conductor with polishing;

FIG. 11A is an example of EDX analysis of a surface SEM image of a conductor without polishing;

FIG. 11B is an example of EDX analysis of a cross-sectional SEM image of the conductor without polishing;

FIG. 11C is an example of EDX analysis of a surface SEM image of a conductor with polishing;

FIG. 11D is an example of EDX analysis of a cross-sectional SEM image of the conductor with polishing;

FIG. 12A is an example of measuring Bi/Ag mass ratios on a surface of a conductor before polishing and after polishing;

FIG. 12B is an example of measuring Bi/Ag mass ratios on a surface of a conductor before polishing and after polishing;

FIG. 12C is an example of measuring Bi/Ag mass ratios on a surface of a conductor before polishing and after polishing;

FIG. 12D is an example of measuring Bi/Ag mass ratios on a surface of a conductor before polishing and after polishing;

FIG. 12E is an example of measuring Bi/Ag mass ratios on a surface of a conductor before polishing and after polishing;

FIG. 12F is an example of measuring Bi/Ag mass ratios on a surface of a conductor before polishing and after polishing; and

FIG. 13 is an example of measuring rates of Bi/Ag mass ratios on the surfaces of the individual conductors after polishing with respect to those before polishing.

### DESCRIPTION OF EMBODIMENTS

Generally, thin film structures are referred to as “films”, “sheets”, etc. depending on the thickness. In this specification, these are not clearly distinguished. Therefore, the term “film” as used herein may include “sheet”.

In this specification, a shape having an additional “substantially” means a partially changed shape, such as a chamfered shape with the corners rounded, a shape with a part of the shape missing, or a shape with a small shape added to the shape.

In this specification, unless otherwise specified, a “surface of a glass plate” refers to the main surface with a large area, excluding the sides (also referred to as side surfaces) of the glass plate.

In this specification, unless otherwise specified, “up and down”, “left and right”, “vertical and horizontal”, and “inside and outside” means “up and down”, “left and right”, “vertical and horizontal”, and “inside and outside” with the windshield for vehicle being fitted into a vehicle (actual usage condition).

In this specification, unless otherwise specified, the symbol “-” (or “to”) indicating a numerical range is used to mean that the numerical values written before and after the symbol are included as the lower limit and upper limit.

Embodiments of the present invention will be described below.

### [Windshield for Vehicle and Manufacturing Method Thereof]

The present disclosure relates to a windshield for vehicle including a laminated glass in which a plurality of glass plates are bonded together with an intermediate film interposed therebetween, and a method for manufacturing the windshield for vehicle.

In this specification, unless otherwise specified, “glass plate” refers to un-tempered glass.

The type of the glass plate that is a material of the laminated glass is not particularly limited, and examples thereof include soda lime glass, borosilicate glass, aluminosilicate glass, lithium silicate glass, quartz glass, sapphire glass, and alkali-free glass.

The thickness of the laminated glass is not particularly limited, and is preferably 2 to 6 mm for use as a windshield for vehicle.

When the laminated glass consists of two glass plates, the thickness of the glass plate on the vehicle inner side and the thickness of the glass plate on vehicle outer side may be identical or non-identical. The thickness of the glass plate on the vehicle inner side is preferably 0.3 to 2.3 mm. When the thickness of the glass plate on the vehicle inner side is 0.3 mm or more, handling properties are good, and when the thickness is 2.3 mm or less, the mass is not too large. The thickness of the glass plate on the vehicle outer side is preferably 1.0 to 3.0 mm. When the thickness of the glass plate on vehicle outer side is 1.0 mm or more, the strength such as tolerance to stone chips is sufficient, and when the thickness is 3.0 mm or less, the mass of the laminated glass is not too large, which is preferable in terms of vehicle fuel efficiency. It is preferable that the thickness of the glass plate on the vehicle outer side and the thickness of the glass plate on the vehicle inner side are both 1.8 mm or less so that both the weight reduction and sound insulation properties of the laminated glass can be achieved.

The windshield for vehicle may have a curved shape such that the windshield is convex to the vehicle outer side when the windshield is attached to the vehicle. When the windshield for vehicle is a laminated glass, the glass plate on the vehicle inner side and the glass plate on the vehicle outer side may both have a curved shape such that they are convex to the vehicle outer side. The windshield for vehicle may have a single curved shape that is curved in only one direction, either the left-right direction or the up-down direction, or the windshield may have a multi-curved shape that is curved in the left-right direction and the up-down direction. The curvature radius of the windshield for vehicle may be between 2000 and 11000 mm. The windshield for vehicle may have the curvature radius in the left-right direction and that in the up-down direction that are identical or non-identical. Gravity forming, press forming, roller forming, etc. are used for bending and forming the windshield for vehicle.

The laminated glass may have a functional film having functions such as water repellency, low reflectivity, low radioactivity, ultraviolet shielding, infrared shielding, and coloring on at least a part of region of surface.

The laminated glass may have a functional film having functions such as low reflectivity, low radioactivity, ultraviolet shielding, infrared shielding, and coloring in at least a part of the region of the inside. At least a part of region of the intermediate film of the laminated glass may have functions such as ultraviolet shielding, infrared shielding, and coloring.

The intermediate film of laminated glass may be a single layer film or a laminated film.

The laminated glass may have a light-shielding layer on a predetermined region of the surface. The light-shielding layer can be formed by a known method, for example, by applying a ceramic paste containing a black pigment and glass frit to a predetermined region on the surface of a glass plate, which is a material for laminated glass, and firing the ceramic paste. The thickness of the light-shielding layer is not particularly limited, and is, for example, 5 to 20 μm. The light-shielding layer can be formed in the peripheral region of any surface of the laminated glass. The light-shielding layer can be formed, for example, in the peripheral region of the interior surface of the glass plate on the vehicle inner side and/or the glass plate on the vehicle outer side.

In the present disclosure, a laminated glass includes a glass plate with a terminal that has: a glass plate; a conductor that is formed on one surface of the glass plate, is made of a material containing silver and glass frit, and has a terminal joint portion to which a terminal is joined; and a terminal joined onto the terminal joint portion of the conductor with lead-free solder interposed therebetween.

In this specification, the “terminal joint portion” of the conductor refers to a portion of the conductor immediately underneath the lead-free solder.

The conductor may be formed directly on the surface of the glass plate in contact with the glass plate, or may be formed on any component formed on the surface of the glass plate.

The conductor may be formed on the glass plate with the terminal on the intermediate film side, or may be formed on the glass plate with the terminal on the side opposite to the intermediate film side.

The glass plate with the terminal can have a light-shielding layer between the glass plate and the terminal joint portion of the conductor. In this case, the conductor is formed on the light-shielding layer formed on the glass plate.

The conductor having a terminal joint portion is formed through a method for applying a silver-containing paste containing silver powder and glass frit onto a glass plate and firing the paste.

The silver-containing paste contains silver powder and glass frit, and can further contain a vehicle and additives as necessary.

Silver powder includes particles containing silver and/or a silver alloy. The content of silver powder in the silver-containing paste is preferably 65 to 85% by mass, more preferably 75 to 85% by mass, particularly preferably 80 to 85% by mass. If the content of the silver powder is within this range, the specific resistance of the conductor can be easily adjusted within a suitable range.

The average particle diameter of the silver powder is preferably 0.1 to 10 m, more preferably 0.1 to 7 μm. If the average particle diameter of the silver powder is within this range, the specific resistance of the conductor can be easily adjusted within a suitable range.

In this specification, unless otherwise specified, the “average particle diameter of silver powder” refers to the average particle diameter (D50) measured with a laser scattering particle size distribution analyzer.

Examples of the glass frit include Bi₂O₃—B₂O₃—SiO₂-based glass frit and B₂O₃—SiO₂-based glass frit. The content of glass frit in the silver-containing paste is preferably 2 to 10% by mass, more preferably 3 to 8% by mass. If the glass frit content is 2% by mass or more, the conductor can be easily sintered, and if the content is 10% by mass or less, the specific resistance of the conductor can be easily adjusted within a suitable range.

Examples of the vehicle include resin solutions in which binder resins such as ethyl cellulose resins, acrylic resins, and alkyd resins are dissolved in solvents such as a-terpineol, butyl carbitol acetate, and ethyl carbitol acetate. The content of vehicle in the silver-containing paste is preferably 10 to 45% by mass, more preferably 15 to 25% by mass.

Examples of the additive include resistance adjusters such as Ni, Al, Sn, Pt, and Pd; colorants such as V, Mn, Fe, Co, Mo, and compounds thereof. The content of additives in the silver-containing paste (in the case of a plurality of types of additives, the total amount) is preferably 2% by mass or less, more preferably 1% by mass or less.

The electrical conductor can include or be electrically connected to an electric function portion.

Examples of the electric function portion include one or more electric heating wires, an electric heating layer, an antenna, a light control layer, a light emitting element, and a combination thereof. Examples of the light emitting element include an LED (light emitting diode) and an OLED (organic light emitting diode).

The one or more electric heating wires or an electric heating layer make it possible to remove fog, frost, snow, ice, etc. and prevent them from adhering. The one or more electric heating wires or an electric heating layer can be used, for example, to prevent wipers from freezing, and to improve sensing accuracy by optical apparatuses including optical devices such as cameras and radars.

The electric function portion can be manufactured by a known method.

The conductor can include a feeding portion for feeding electricity to the electric function portion, and the feeding portion can include a terminal joint portion. The feeding portion can include a pair of feeding electrodes (also referred to as a pair of busbars), and each feeding electrode can include a terminal joint portion.

For example, one feeding electrode is a positive electrode and is connected to a power source or a signal source provided in the vehicle with the feeding member interposed therebetween, and the other feeding electrode is a negative electrode and is connected to the vehicle body (ground) with the feeding member interposed therebetween. Note that the feeding electrode for the positive electrode may be single or plural, and the feeding electrode for the negative electrode may be single or plural.

When the conductor is connected to an electric function portion, the conductor and the electric function portion may be formed on the same glass surface or on different glass surfaces.

A feeding member including a round-wire-shaped or foil-shaped conducting wire can be fixed to the terminal. The term “conducting wire” as used herein includes a covered conducting wire in which one or more conducting wires are covered with an insulating material. As the feeding member, a covered conducting wire is preferable.

Examples of the specific form of the feeding member include a harness and a cable. Examples of the round-wire-shaped conducting wire include a wire harness. Examples of the foil-shaped conducting wire include a flat harness and a flexible printed circuit board.

The feeding member has a conductor-exposed portion, and a terminal is fixed to this conductor-exposed portion. The material of the conductor-exposed portion is not particularly limited, and examples thereof include Cu, Al, Ag, Au, Ti, Sn, Zn, alloys thereof, and combinations thereof. The conductor-exposed portion may be formed by plating the surface of the main metal with another metal. The conductor-exposed portion may have a thin oxide film on the surface.

Lead-free solder is solder that contains little or no lead, and any known solder can be used. The lead content in the lead-free solder is 500 ppm or less. Examples of lead-free solder include: SnAg-based solder containing Sn and Ag; SnAgCu-based solder containing Sn, Ag, and Cu; SnZnBi-based solder containing Sn, Zn, and Bi; SnCu-based solder containing Sn and Cu; SnAgInBi-based solder containing Sn, Ag, In, and Bi; and SnZnAl-based solder containing Sn, Zn, and Al.

From the viewpoint of environmental resistance and the like, lead-free solders such as SnAg-based and SnAgCu-based solders are preferred.

The melting point of lead-free solder such as SnAg-based and SnAgCu-based solder is higher than that of leaded solder, and is for example, about 220° C. In using lead-free solder such as SnAg-based and SnAgCu-based solder, the solder joint temperature is, for example, about 300° C. The present disclosure is particularly effective in using lead-free solders such as SnAg-based and SnAgCu-based solders having high melting points.

Examples of the composition of SnAg-based lead-free solder include Sn: 98% by mass, and Ag: 2% by mass. Examples of the composition of SnAgCu-based lead-free solder include Sn: 96.5% by mass, Ag: 3.0% by mass, and Cu: 0.5% by mass.

The present disclosure provides a method for manufacturing a windshield for vehicle, the method including a step of soldering a conductor and a terminal together using lead-free solder and being able to increase breaking strength after terminal attachment.

The method for manufacturing a windshield for vehicle according to the present disclosure includes:
a step (S2) of applying a silver-containing paste containing silver and glass frit, which are materials of a conductor having a terminal joint portion, on the glass plate, which is a material of a glass plate with a terminal;
a step (S3) of firing the glass plate coated with the materials of the conductor to form the conductor including the terminal joint portion;
a step (S5) of polishing the surface of a region including the terminal joint portion of the conductor; and
a step (S6) of joining the terminal onto the terminal joint portion, the surface of which has been polished, with lead-free solder interposed therebetween.

The porosity of the terminal joint portion of the conductor after the step (S5) is 10% or less.

As explained in the BACKGROUND section, generally when solder joining is implemented on a glass plate with a conductor, the glass plate with the conductor is subjected to local high-temperature heating and temperature drop from high temperature to normal temperature, and stress may remain after temperature drop. This residual stress may cause cracks to occur in the glass plate with the conductor after manufacturing of the window glass.

Generally, the melting point of lead-free solder is higher than that of leaded solder, so when lead-free solder is used, a larger stress is generated in the glass plate with the conductor. In addition, since lead-free solder does not contain lead, which has a low elastic modulus, lead-free solder has a higher elastic modulus and is less likely to deform than leaded solder, so it is difficult to alleviate the generated stress. For these reasons, the problem of residual stress after joining and the resulting cracking after manufacturing can occur, especially when lead-free solder is used.

The method for manufacturing a windshield for vehicle according to the present disclosure includes: a step (S5) of polishing the surface of a region including the terminal joint portion of the conductor; and a step (S6) of joining the terminal onto the terminal joint portion, the surface of which has been polished, with lead-free solder interposed therebetween. In this method, in the step (S5) (polishing step), it is possible to: reduce the porosity of the terminal joint portion of the conductor and the amount of components of the glass frit on the surface of the terminal joint portion of the conductor; and apply residual stress to the terminal joint portion of the conductor. This allows increase in the breaking strength after terminal attachment.

The porosity of the terminal joint portion of the conductor after the step (S5) (polishing step) is preferably small, and is 10% or less, preferably 8% or less, more preferably 7% or less, particularly preferably 3% or less. The lower limit of the porosity of the terminal joint portion of the conductor after the step (S5) (polishing step) is, for example, 0.5%.

The porosity of the terminal joint portion of the conductor before the step (S5) (polishing step) is larger than the porosity of the terminal joint portion of the conductor after the step (S5) (polishing step). If this condition is satisfied, the porosity of the terminal joint portion of the conductor before the step (S5) (polishing step) may be more than 10%, or 10% or less. The porosity of the terminal joint portion of the conductor before the step (S5) (polishing step) is, for example, 15 to 16%.

According to the study conducted by the present inventors, it was found that a conductor containing silver and glass frit has many voids (vacancies) in the conductor in an unpolished state. It is thought that voids (vacancies) in the conductor become a stress concentration source, leading to a decrease in breaking strength after terminal attachment.

In addition, according to the study conducted by the present inventors, it was found that when a conductor containing silver and glass frit is in an unpolished state, a large amount of components of the glass frit is present on the surface of the conductor. In particular, it has been found that when a conductor is formed on a light-shielding layer, more components of the glass frit are present on the surface of the conductor. It is presumed that these are because in firing of the material for forming the conductor and the material for forming the light-shielding layer used as necessary, a part of components of the glass frit contained in these materials move to the surface layer side.

In general, the wettability of lead-free solder to components of the glass frit is low. It is thought that: when a large amount of components of the glass frit is present on the surface of the conductor, the joining strength of the lead-free solder to the conductor decreases, making it difficult to form a well-shaped solder fillet, which decreases the breaking strength after terminal attachment.

According to the study conducted by the present inventors, it has been found that polishing the surface of the conductor can reduce voids (vacancies) in the conductor that can become the stress concentration source. It is presumed that polishing the surface of the conductor reduces the depth of the voids present on the surface, and further the stretched silver fills voids present on the surface and surface layer portion of the conductor.

It was also found that polishing the surface of the conductor can reduce the amount of components of the glass frit present on the surface of the conductor. It is presumed that polishing the surface of the conductor removes components of the glass frit that are present in large quantities on the surface. The amount of components of the glass frit present on the surface of the conductor can be reduced, making it possible to improve the wettability of lead-free solder to a conductor, to improve the joining strength of lead-free solder to a conductor, and to form a well-shaped solder fillet.

According to the present disclosure, combination of the above effects allows increase in the breaking strength after terminal attachment.

As the glass frit for the conductor and the light-shielding layer, any known one can be used. As the metal element, those containing Na, Al, Si, P, Zn, Ba, Bi, etc. can be used. Typically, the glass frit for the conductor and the light-shielding layer contains a relatively large amount of Bi, so the proportion of components of the glass frit on the surface of the conductor can be determined by using the Bi/Ag mass ratio as a measure. The Bi/Ag mass ratio indicates that it increases with the increase in the proportion of the components of the glass frit.

Note that when the conductor is formed on the light-shielding layer, as described above, a part of components of the glass frit contained in the material for forming the light-shielding layer may move into the conductor in the manufacturing process. Therefore, the glass frit components contained in the conductor after the step (S3) may include a part of components of the glass frit contained in the material for forming the light-shielding layer.

In the step (S5), the conductor is polished so as not to damage the glass plate and the light-shielding layer provided as necessary.

Since the breaking strength after terminal attachment can be effectively increased in the step (S5), polishing is preferably implemented so as to satisfy at least one of the following conditions (Condition 1-1) to (Condition 1-3).
(Condition 1-1) The rate of the arithmetic mean surface roughness (Ra) of the terminal joint portion of the conductor after polishing with respect to that before polishing is 5 to 80%.
(Condition 1-2) The reduction rate of the film thickness of the terminal joint portion of the conductor after polishing with respect to that before polishing is 4 to 40%.
(Condition 1-3) The rate of Bi/Ag mass ratio of the surface of the terminal joint portion of the conductor after polishing with respect to that before polishing is 10 to 90%.

It is more preferable that two or more of (Condition 1-1) to (Condition 1-3) be satisfied, and it is particularly preferable that all of (Condition 1-1) to (Condition 1-3) be satisfied.

The arithmetic mean surface roughness (Ra), film thickness reduction rate, and Bi/Ag mass ratio can be measured by methods described in the Examples section below.

In Condition 1-1, the rate of the arithmetic mean surface roughness (Ra) of the terminal joint portion of the conductor after polishing with respect to that before polishing is more preferably 5 to 50%, particularly preferably 5 to 20%.

In Condition 1-2, the reduction rate of the film thickness of the terminal joint portion of the conductor after polishing with respect to that before polishing is more preferably 4 to 20%, particularly preferably 4 to 10%.

In Condition 1-3, the rate of Bi/Ag mass ratio of the surface of the terminal joint portion of the conductor after polishing with respect to that before polishing is more preferably 10 to 50%, particularly preferably 10 to 20%.

In an aspect in which a glass plate with a terminal has a light-shielding layer between the glass plate and the terminal joint portion of the conductor, the method can include a step (S1), before step (S2), of applying a ceramic paste containing a black pigment and glass frit, which are materials for the light-shielding layer, on a glass plate, which is the material for the glass plate with the terminal. In this case, in step (S3), the material for the light-shielding layer can be fired to form the light-shielding layer.

In the laminated glass, it is possible that: the glass plate with the terminal has an exposed portion that is not covered by the glass plate facing the glass plate with the terminal with the intermediate film interposed therebetween; the conductor is formed on the intermediate film side of the glass plate with the terminal; and the terminal joint portion of the conductor is formed in the exposed portion of the glass plate with the terminal.

In this aspect, there can be a step (S4) of bonding a plurality of glass plates together with an intermediate film interposed therebetween, between the step (S3) and the step (S5).

In the laminated glass, the conductor can be formed on the side opposite to the intermediate film side of the glass plate with the terminal.

Also in this aspect, there can be a step (S4) of bonding a plurality of glass plates together with an intermediate film interposed therebetween, between the step (S3) and the step (S5).

The windshield for vehicle of the present disclosure
includes a laminated glass in which a plurality of glass plates are bonded together with an intermediate film interposed therebetween, and
the laminated glass includes a glass plate with a terminal that has: a glass plate; a conductor that is formed on one surface of the glass plate, is made of a material containing silver and glass frit, and has a terminal joint portion to which the terminal is joined; and the terminal joined onto the terminal joint portion of the conductor with lead-free solder interposed therebetween.

In the windshield for vehicle of the present disclosure, the conductor has a polished surface in a region including the terminal joint portion, and has a polished portion with a porosity of 10% or less.

According to the present disclosure, it is possible to provide a windshield for vehicle that includes a portion where a conductor and a terminal are joined using lead-free solder and can have a higher breaking strength after terminal attachment.

The porosity of the polished portion is preferably small, more preferably 8% or less, particularly preferably 7% or less, particularly preferably 3% or less. The lower limit of the porosity of the polished portion is, for example, 0.5%.

The conductor can include a non-polished portion that does not have a polished surface in a region that does not include the terminal joint portion. The porosity of the non-polished portion 20NP is greater than the porosity of the polished portion, and is 15 to 16%, for example.

Since the breaking strength after terminal attachment can be effectively increased, the conductor preferably satisfies at least one of the following conditions (Condition 2-1) to (Condition 2-3).
(Condition 2-1) The rate of the arithmetic mean surface roughness (Ra) of the polished portion with respect to that of the non-polished portion is 5 to 80%.
(Condition 2-2) The reduction rate of film thickness of the polished portion with respect to that of the non-polished portion is 4 to 40%.
(Condition 2-3) The rate of Bi/Ag mass ratio of the surface of the polished portion with respect to that of the non-polished portion is 10 to 90%.

It is more preferable that two or more of (Condition 2-1) to (Condition 2-3) be satisfied, and it is particularly preferable that all of (Condition 2-1) to (Condition 2-3) be satisfied.

In condition 2-1, the rate of the arithmetic mean surface roughness (Ra) of the polished portion with respect to that of the non-polished portion is more preferably 5 to 50%, particularly preferably 5 to 20%.

In condition 2-2, the reduction rate of the film thickness of the polished portion with respect to that of the non-polished portion is more preferably 4 to 20%, particularly preferably 4 to 10%.

In condition 2-3, the rate of the Bi/Ag mass ratio of the surface of the polished portion with respect to that of the non-polished portion is more preferably 10 to 50%, particularly preferably 10 to 20%.

Surface polishing of the conductor can be implemented by a known method, and may be a manual method or an electric-powered method. The manual methods include a method for rubbing the surface of the conductor using a polishing member such as a metal fiber and a polishing eraser. The electric-powered methods include a method for polishing the surface of the conductor using an electric-powered cutting tool (also referred to as a hand grinder).

Examples of metal fibers include steel wool. Metal fibers come in several grit numbers depending on the average fiber diameter. In the method using metal fibers, adjustment is performed in the grit number and amount of the metal fiber to be used, the force in rubbing, the number of times of rubbing, the duration of rubbing, and the like, thereby making it possible to implement polishing so as to satisfy at least one condition among (Condition 1-1) to (Condition 1-3) or at least one condition among (Condition 2-1) to (Condition 2-3).

Polishing erasers include an abrasive (also referred to as abrasive grains) such as alumina and silica, and rubber, and are commercially available under the names of sand erasers, rust erasers, and the like. There are several grit numbers depending on the average particle diameter of the abrasive (abrasive grains) contained. Adjustment is performed in the grit number of the polishing eraser, the force in rubbing, the number of times of rubbing, the duration of rubbing, and the like, thereby making it possible to implement polishing so as to satisfy at least one condition among (Condition 1-1) to (Condition 1-3) or at least one condition among (Condition 2-1) to (Condition 2-3).

Examples of commercially available electric-powered cutting tools (hand grinders) include “Leutor (registered trademark)” manufactured by Nihon Seimitsu Kikai Kosaku Co., Ltd. Electric-powered cutting tools can each be used with a tip tool for polishing being attached. As the tip tool, an angle tool is preferable from the viewpoint of workability. Examples of the angle tools include: angle tools each consisting of a combination of a rubber pad that has a polishing disc mounting surface and is attached to an electric-powered cutting tool, and a polishing disc that is attached to the rubber pad; and ceramic angle tools (also referred to as ceramic angle grindstones) that contain ceramic as an abrasive (abrasive grains), a binder, and an elastic body. There are two types of polishing discs: discs containing an abrasive (abrasive grains) and discs containing no abrasive, and when a disc containing no abrasive is used, it is necessary to use an abrasive together. Examples of the polishing disc include a sandpaper disc, a felt disc containing no abrasive, a felt disc containing an abrasive, a nonwoven fabric disc made of nylon and containing an abrasive (also referred to as a cushion disc). Discs and ceramic angle tools containing an abrasive come in several grit numbers depending on the average particle diameter of the abrasive (abrasive grains).

Adjustment is performed in the type and grit number of the tip tool to be used, the rotational speed, the polishing time, and the like, thereby making it possible to implement polishing so as to satisfy at least one condition among (Condition 1-1) to (Condition 1-3) or at least one condition among (Condition 2-1) to (Condition 2-3).

In general, if the material is the same, as the grit number decreases, the average size of the abrasive (abrasive grains) contained increases, so that the polishing capacity tends to increase. In any polishing method, the polishing conditions are adjusted so that the polishing capacity is not too large not to damage the glass plate and the light-shielding layer provided as necessary.

### First Embodiment

A structure of a windshield for vehicle according to a first embodiment of the present invention will be described with reference to drawings.

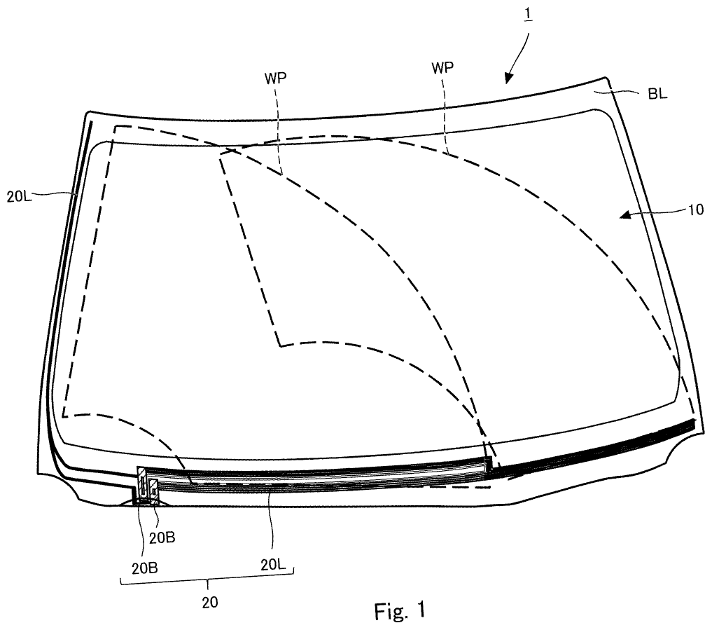

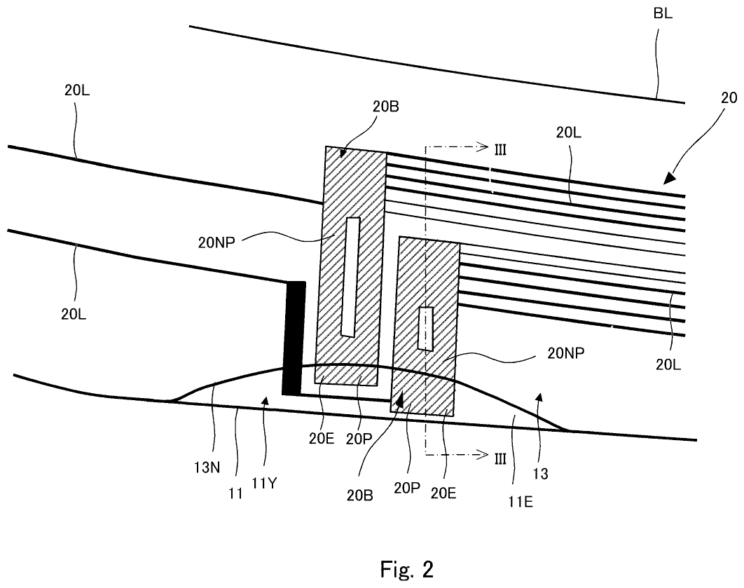

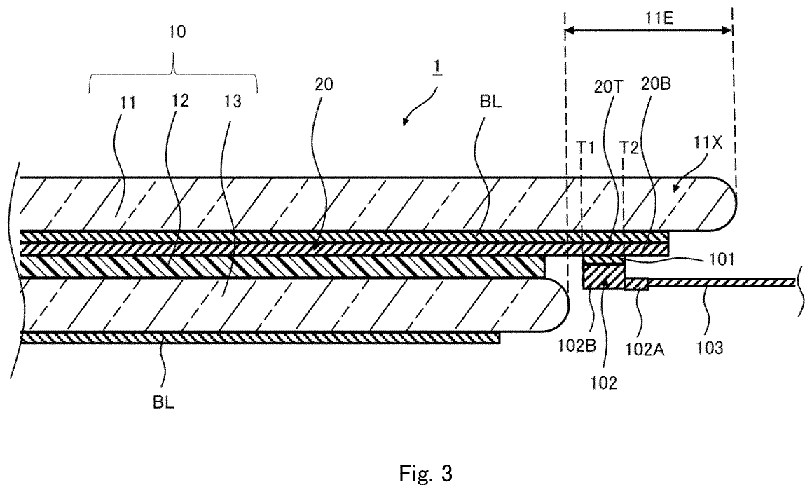

FIG. 1 is an overall plan view of a windshield for vehicle of this embodiment. FIG. 2 is a partially enlarged plan view of FIG. 1. FIGS. 1 and 2 are diagrams before joining a terminal. Both FIGS. 1 and 2 are perspective views, the front side in the figures is the vehicle inner side, and the back side in the figures is the vehicle outer side. FIG. 3 is a cross-sectional view taken along a line III-III in FIG. 2. In FIG. 3, the upper side of the figure is the vehicle outer side, and the lower side of the figure is the vehicle inner side. All of these figures are schematic diagrams, and for ease of visual recognition, the scale of each component is made different from the actual one as appropriate in each drawing.

The planar shape of the windshield for vehicle 1 can be designed as appropriate, and examples of the shapes include a shape in which a substantially trapezoidal-shaped plate in a plan view is curved as a whole, as shown in FIG. 1.

As shown in FIG. 3, the windshield for vehicle 1 of this embodiment includes a laminated glass 10 in which a plurality of glass plates are bonded together with an intermediate film 12 interposed therebetween.

In this embodiment, the laminated glass 10 includes: a glass plate with a terminal 11X that includes: a glass plate 11; a conductor 20 that is formed on the one surface of the glass plate 11, is made of a material containing silver and glass frit, and has a terminal joint portion 20T to which the terminal 102 is joined; and a terminal 102 joined onto the terminal joint portion 20T of the conductor 20 with lead-free solder 101 interposed therebetween.

In the illustrated example, the laminated glass 10 is a laminated glass in which a glass plate with a terminal 11X and a glass plate 13 are bonded together with an intermediate film 12 interposed therebetween. In this embodiment, the glass plate with the terminal 11X is the glass on the vehicle outer side, and the glass plate 13 is the glass on the vehicle inner side. The laminated glass may be made by bonding three or more glass plates together.

In this embodiment, the conductor 20 has a function of melting frost, snow, ice, etc. adhering to the wipers and of preventing the wipers from freezing. In FIG. 1, the region indicated by broken lines with the reference character WP is the region where the wipers can move.

As shown in FIGS. 1 and 2, the conductor 20 includes an electric function portion including one or more electric heating wires 20L or an electric heating layer. Here, a case in which the conductor 20 includes a plurality of electric heating wires 20L is illustrated as an example. The conductor 20 further includes a feeding portion including a pair of feeding electrodes (a pair of busbars) 20B. One of the pair of feeding electrodes (a pair of busbars) 20B is a positive electrode, and the other thereof is a negative electrode. The conductor 20 can be formed, for example, at the lower end portion and/or at least one side end portion of the windshield for vehicle 1. The configuration, pattern, and formation region of the conductor 20 can be designed as appropriate.

As shown in FIGS. 2 and 3, in the laminated glass 10, the glass plate 13 has a cut-out portion 13N at the lower end portion. As a result, the glass plate with the terminal 11X has an exposed portion 11E that is not covered by the glass plate 13 facing the glass plate with the terminal 11X with the intermediate film 12 interposed therebetween. In this embodiment, the conductor 20 is formed on the intermediate film 12 side of the glass plate with the terminal 11X. At least a part of each of the pair of feeding electrodes (a pair of busbars) 20B is formed in the exposed portion 11E of the glass plate with the terminal 11X, and is exposed without being covered by the glass plate 13. An exposed portion 20E of the feeding electrode 20B includes the terminal joint portion 20T of the conductor 20, and the terminal 102 is joined onto the terminal joint portion 20T of the conductor 20 with lead-free solder 101 interposed therebetween. A feeding member 103 including a round-wire-shaped or foil-shaped conducting wire is fixed to each terminal 102.

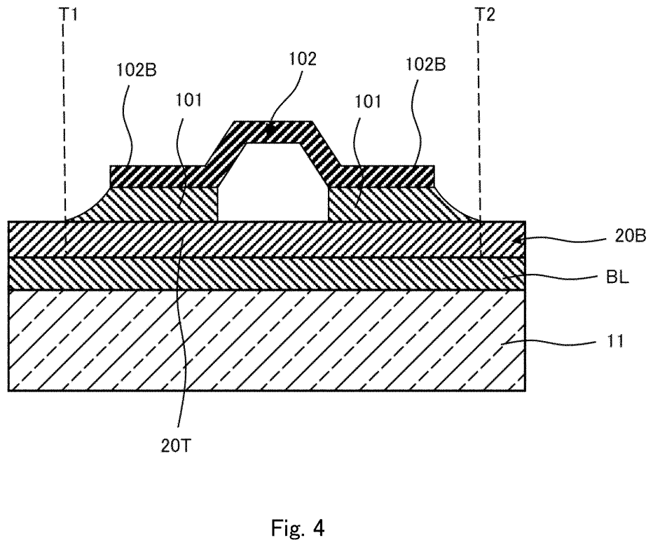

As shown in FIGS. 3 and 4, the terminal joint portion 20T of the conductor 20 is a portion immediately underneath the lead-free solder 101. In these figures, the region of the terminal joint portion 20T is a region sandwiched between two broken lines T1 and T2.

FIG. 4 is a partially enlarged cross-sectional view of the laminated structure of the terminal 102, the lead-free solder 101, the power feeding electrode 20B, the light-shielding layer BL, and the glass plate 11, shown in FIG. 3, viewed from the left side of FIG. 3. Here, the laminated structure is turned upside down for easier visual recognition.

Note that the position of the terminal joint portion 20T of the conductor 20 is not clearly determined from the beginning. In the exposed portion 20E of the power feeding electrode 20B, the terminal joint portion 20T is the portion immediately underneath the lead-free solder 101 after the terminal 102 is joined to the feeding electrode 20B with the lead-free solder 101 interposed therebetween.

In this embodiment, the exposed portion 20E of each power feeding electrode 20B has a polished surface of a region including the terminal joint portion 20T. In the example shown in FIG. 2, in each feeding electrode 20B, the entire exposed portion 20E is a polished portion 20P having a polished surface, (that is, the exposed portion 20E coincides with the polished portion 20P), and the other portion (non-exposed portion) is a non-polished portion 20NP having no polished surface. The region of the polished portion 20P may be smaller than the region of the exposed portion 20E.

In the polished portion 20P of the conductor 20, the porosity is 10% or less, more preferably 8% or less, particularly preferably 7% or less, particularly preferably 3% or less. The lower limit of the porosity of the polished portion 20P of the conductor 20 is, for example, 0.5%.

The porosity of the non-polished portion 20NP of the conductor 20 is larger than the porosity of the polished portion 20P, and may be more than 10%, or 10% or less, and is 15 to 16%, for example.

Since the breaking strength after terminal attachment can be effectively increased, the conductor 20 preferably satisfies at least one of the following conditions (Condition 2-1) to (Condition 2-3).
(Condition 2-1) The rate of the arithmetic mean surface roughness (Ra) of the polished portion 20P with respect to that of the non-polished portion 20NP is 5 to 80%.
(Condition 2-2) The reduction rate of film thickness of the polished portion 20P with respect to that of the non-polished portion 20NP is 4 to 40%.
(Condition 2-3) The rate of Bi/Ag mass ratio of the surface of the polished portion 20P with respect to that of the non-polished portion 20NP is 10 to 90%.

In condition 2-1, the rate of the arithmetic mean surface roughness (Ra) of the polished portion 20P with respect to that of the non-polished portion 20NP is more preferably 5 to 50%, particularly preferably 5 to 20%.

In condition 2-2, the reduction rate of the film thickness of the polished portion 20P with respect to that of the non-polished portion 20NP is more preferably 4 to 20%, particularly preferably 4 to 10%.

In condition 2-3, the rate of the Bi/Ag mass ratio of the surface of the polished portion 20P with respect to that of the non-polished portion 20NP is more preferably 10 to 50%, particularly preferably 10 to 20%.

As shown in FIG. 1, the windshield for vehicle 1 of this embodiment has a light-shielding layer BL in the peripheral region. The light-shielding layer BL can contain a black pigment and glass frit. The glass surface on which the light-shielding layers BL are formed, and the region where the light-shielding layers BL are formed can be designed as appropriate.

In this embodiment, the light-shielding layer BL is formed in the peripheral region of at least one surface of the glass plate 11, and a conductor 20 is formed on a light-shielding layer BL formed on the one surface of the glass plate 11. In this embodiment, as shown in FIG. 3, a light-shielding layer BL and a conductor 20 are laminated on the peripheral region of the surface of the glass plate 11 on the intermediate film 12 side. In other words, the glass plate with the terminal 11X has the light-shielding layer BL between the glass plate 11 and the terminal joint portion 20T of the conductor 20.

As illustrated, a light-shielding layer BL may be formed in the peripheral region of at least one surface of the glass plate 13. In the illustrated example, the light-shielding layer BL is formed in the peripheral region of the surface of the glass plate 13 on the side opposite to the intermediate film 12.

The feeding member 103 is preferably a round-wire-shaped or foil-shaped conducting wire, more preferably a round-wire-shaped or foil-shaped covered conducting wire. The covered conducting wire is preferably a wire harnesses, a flat harnesses, or the like.

The feeding member 103 has a head end portion having a conductor-exposed portion to which the terminal 102 is fixed.

As the terminal 102, a known crimp terminal is preferable. The crimp terminal preferably has: a feeding member joint portion 102A (see FIG. 3) in contact with the head end portion (conductor-exposed portion) of the feeding member 103; and a solder joint portion 102B in contact with the lead-free solder 101 (see FIGS. 3 and 4).

When a wire harness is used as the feeding member 103, the crimp terminal is preferably a crimp terminal including: a feeding member joint portion 102A that caulks and fixes the head end portion (conductor-exposed portion) of the wire harness and has a tubular shape or the like; and a bridge-shaped portion having solder joint portions 102B at opposing ends, as shown in FIGS. 3 and 4. The crimp terminal may be one that has one solder joint portion 102B without having a bridge-shaped portion.

The terminal 102 is preferably a metal terminal such as copper, brass, or stainless steel. The metal terminal may be at least partially covered with an insulating material.

For example, the terminal 102 (preferably a crimp terminal) is caulked and fixed to the head end portion (conductor-exposed portion) of the feeding member 103, and the terminal 102 is joined to the terminal joint portion 20T in the exposed portion 20E of the feeding electrode 20B with lead-free solder 101 interposed therebetween.

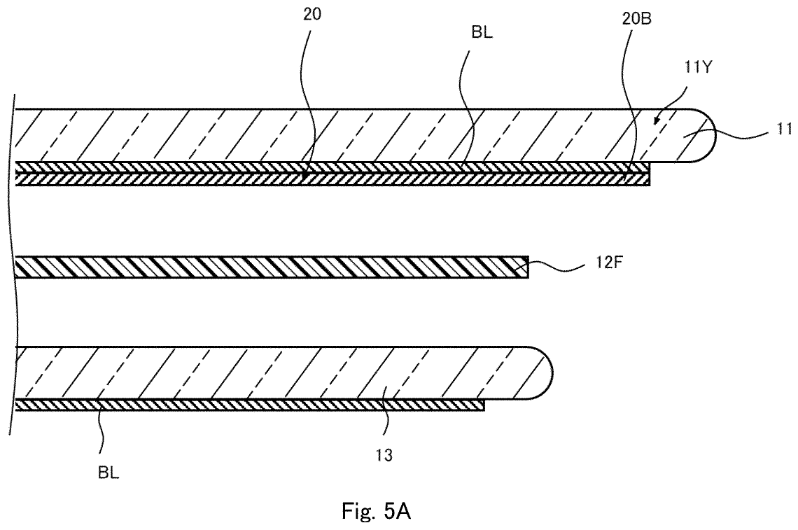

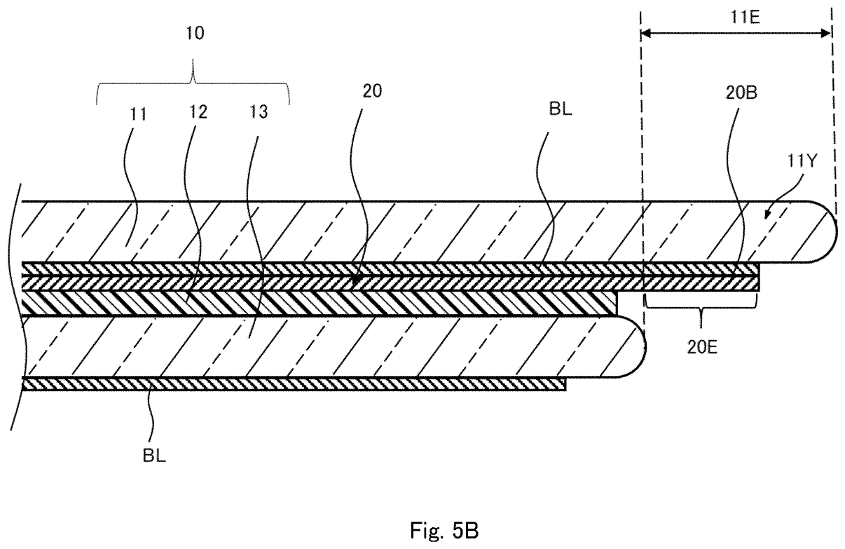

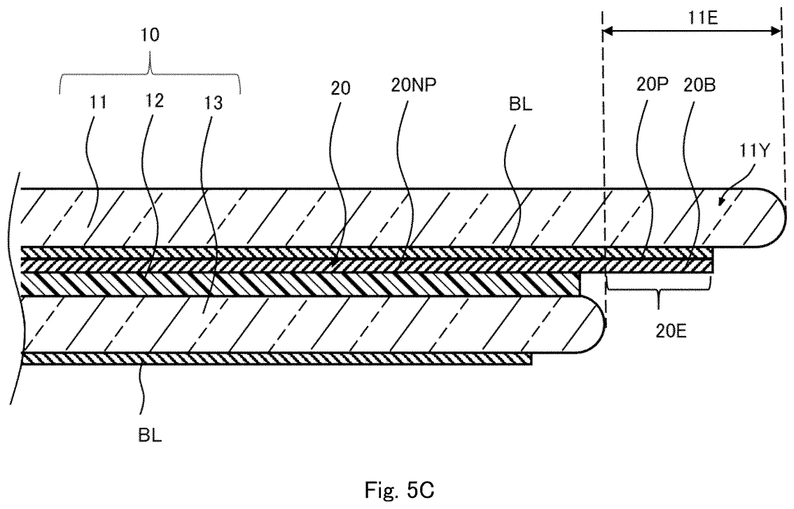

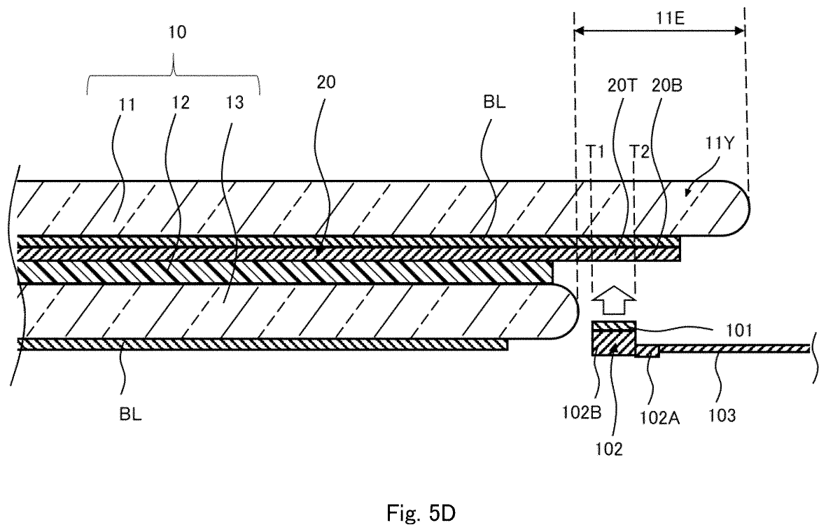

Each step of a method for manufacturing a windshield for vehicle according to this embodiment will be described with reference to the drawings. FIGS. 5A to 5D are schematic cross-sectional views corresponding to FIG. 3.

### (Step (S1))

First, a ceramic paste containing a black pigment and glass frit, which are the materials of the light-shielding layer BL, is applied, as necessary, to a predetermined region (peripheral region in this embodiment) of one or more glass plates that are the materials for laminated glass, and the paste is dried to form a ceramic paste layer. The drying conditions can be appropriately designed depending on the paste composition, and are preferably, for example, 120 to 150° C. for about 5 minutes.

In this embodiment, a ceramic paste layer can be formed in a predetermined region of the glass plate 11, which is the material of the glass plate with the terminal 11X, and/or the glass plate 13. The glass plate 13 is processed into a shape having a cut-out portion 13N in advance.

### (Step (S2))

A silver-containing paste containing silver powder and glass frit, which are the materials of the conductor 20, is applied to directly on the outer glass plate 11 or to the ceramic paste layer formed on the outer glass plate 11 as necessary, and the paste is dried to form a silver-containing paste layer. The drying conditions can be appropriately designed depending on the paste composition, and are preferably, for example, 120 to 150° C. for about 5 minutes.

### (Step (S3))

Next, each glass plate is heated to a temperature of its softening point (for example, 600 to 700° C.) or above, and each glass plate is bent and formed. In this step, the silver-containing paste layer and the ceramic paste layer formed as necessary are simultaneously fired, and the light-shielding layer BL and the conductor 20 are formed. After firing, each glass plate is slowly cooled.

After the above steps, as shown in FIG. 5A, there are obtained: a glass plate with a conductor 11Y that has a light-shielding layer BL on one surface of the outer glass plate 11 as necessary and has a conductor 20 formed directly on the outer glass plate 11 or on the light-shielding layer BL; and a glass plate 13 that may have a light-shielding layer BL.

### (Step (S4))

Next, as shown in FIG. 5A, the glass plate with the conductor 11Y and the glass plate 13 are bonded together with a resin film 12F, which is the material of an intermediate film 12, interposed therebetween. After this step, a laminated glass 10 is obtained as shown in FIG. 5B.

The constituent resin of the resin film 12F is not particularly limited, and is preferably one or more types of resin selected from the group consisting of polyvinyl butyral (PVB), ethylene vinyl acetate copolymer (EVA), cycloolefin polymer (COP), polyurethane (PU), and ionomer resin, for example. The resin film 12F may contain one or more types of additives other than resin, as necessary. Examples of additives include colorants such as pigments. The resin film 12F may be colorless and transparent, or colored and transparent. The resin film 12F may have a single layer structure or a laminated structure of two or more layers.

The bonding can be implemented by thermocompression bonding. Examples of the thermocompression bonding methods include: a method for placing a temporary laminate obtained by stacking a plurality of members shown in FIG. 5A in a bag made of rubber or the like, and heating it in a vacuum; a method for pressurizing and heating the temporary laminate using an automatic pressurizing and heating treatment apparatus, an autoclave, etc.; and combinations thereof.

The thermocompression bonding conditions of temperature, pressure, and time are not particularly limited, and are designed depending on the type and temperature of the resin film 12F. The thermocompression bonding conditions just needs to be conditions such that the resin film 12F is softened, sufficiently pressurized, and the glass plate with the conductor 11Y and the glass plate 13, which may have a light-shielding layer BL, are sufficiently bonded together with the resin interposed therebetween. Thermocompression bonding may be implemented in a plurality of stages by changing the method or conditions.

Note that the constituent resin of the resin film 12F softens and spreads so as to fill the space between the glass plate with the conductor 11Y and the glass plate 13, which may have a light-shielding layer BL.

### (Step (S5))

Next, the surface of the region including the terminal joint portion 20T of the conductor 20 is polished. In this embodiment, in the exposed portion 20E of each feeding electrode 20B, the surface of the region including the terminal joint portion 20T is polished. The surface of the entire exposed portion 20E may be polished, or the surface of a part of the exposed portion 20E may be polished. After this step, as shown in FIGS. 2 and 5C, a laminated glass 10 is obtained that has a conductor 20 consisting of a polished portion 20P and a non-polished portion 20NP.

Note that in the conductor 20, the film thickness of the polished portion 20P becomes thinner than the film thickness of the non-polished portion 20NP due to polishing.

### (Step (S6))

Next, as shown in FIG. 5D, the terminal 102 is joined onto the terminal joint portion 20T of the polished portion 20P included in the exposed portion 20E of each feeding electrode 20B with the lead-free solder 101 interposed therebetween. To the terminal 102, a feeding member 103 preferably including a round-wire-shaped or foil-shaped conducting wire is fixed (preferably fixed by caulking) in advance by a known method. For the solder jointing, see also FIG. 4.

Solder joining can be implemented by a known method, preferably a method using a soldering iron or resistance heating.

In using a soldering iron, for example, joining can be implemented as follows.

An appropriate amount (for example, 0.05 to 0.10 g) of lead-free solder is attached to each solder joint portion of the terminal. This terminal is placed on the terminal joint portion in which the surface of the conductor has been polished. In this state, the tip of a soldering iron set at a temperature of the melting point of the lead-free solder or above is pressed against the solder joint portion of the terminal to heat and melt the lead-free solder. Thereafter, the soldering iron is removed from the terminal, and the lead-free solder is solidified by natural cooling.

Before soldering, it is preferable to apply flux to the surface of the unmelted lead-free solder and/or the surface of the solder joint portion of the terminal. The metal oxide film is melted by the action of the flux, and a sufficient joining state can be obtained.

Before solder joining, it is preferable to place an appropriate amount of lead-free solder on the tip of a soldering iron, and heat and melt it. This solder is called preliminary solder and can improve heat conduction in solder joining.

Generally, in order to join a conductor and solder sufficiently, it is necessary to form an alloy layer containing an alloy of one or more metal elements contained in the conductor and a plurality of metal elements contained in the solder at the joining interface between the conductor and the solder. Therefore, solder joining is implemented by heating the solder to its melting point or above.

The melting point of lead-free solder such as SnAg-based and SnAgCu-based solder is, for example, about 220° C., and in this case, the solder joining temperature is preferably, for example, about 300° C.

The terminal 102 is sealed with a resin such as silicone resin by a known method, as necessary.

In the manner described above, the windshield for vehicle 1 of this embodiment is manufactured.

The method for manufacturing a windshield for vehicle 1 according to this embodiment includes: a step (S5) of polishing the surface of the region including the terminal joint portion 20T of the conductor 20; and a step (S6) of joining the terminal 102 onto the terminal joint portion 20T, the surface of which has been polished, with lead-free solder 101 interposed therebetween. In this method, in the step (S5) (polishing step), it is possible to reduce the porosity of the terminal joint portion 20T of the conductor 20 and the amount of components of the glass frit on the surface of the terminal joint portion 20T of the conductor 20. This allows increase in the breaking strength after terminal attachment. In this method, the porosity of the terminal joint portion 20T of the conductor 20 after the step (S5) (polishing step) can be made 10% or less.

Since the breaking strength after terminal attachment can be effectively increased in the step (S5), polishing is preferably implemented so as to satisfy at least one of the following conditions (Condition 1-1) to (Condition 1-3).
(Condition 1-1) The rate of the arithmetic mean surface roughness (Ra) of the terminal joint portion 20T of the conductor 20 after polishing with respect to that before polishing is 5 to 80%.
(Condition 1-2) The reduction rate of the film thickness of the terminal joint portion 20T of the conductor 20 after polishing with respect to that before polishing is 4 to 40%.
(Condition 1-3) The rate of Bi/Ag mass ratio of the surface of the terminal joint portion 20T of the conductor 20 after polishing with respect to that before polishing is 10 to 90%.

In Condition 1-1, the rate of the arithmetic mean surface roughness (Ra) of the terminal joint portion 20T of the conductor 20 after polishing with respect to that before polishing is more preferably 5 to 50%, particularly preferably 5 to 20%.

In Condition 1-2, the reduction rate of the film thickness of the terminal joint portion 20T of the conductor 20 after polishing with respect to that before polishing is more preferably 4 to 20%, particularly preferably 4 to 10%.

In Condition 1-3, the rate of Bi/Ag mass ratio of the surface of the terminal joint portion 20T of the conductor 20 after polishing with respect to that before polishing is more preferably 10 to 50%, particularly preferably 10 to 20%.

### [Example of Design Change of First Embodiment]

In the first embodiment, an aspect has been described in which the conductor 20 includes: an electric function portion including one or more electric heating wires 20L or an electric heating layer; and a feeding portion including a pair of feeding electrodes (a pair of busbars) 20B. The conductor 20 may be configured not to include an electric function portion, and include only a feeding portion that is connected to an electric function portion not included in the conductor 20.

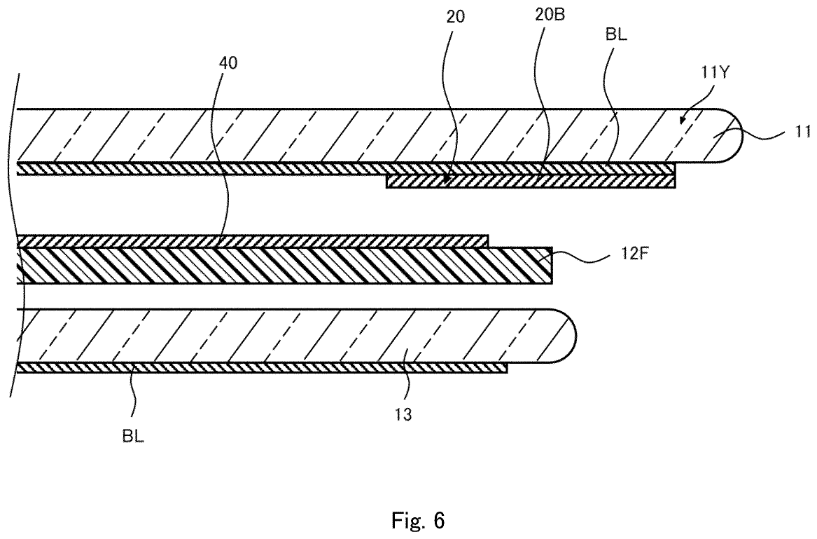

For example, as shown in FIG. 6, a conductor 40 including an electric function portion can be formed on a resin film 12F that is the material of the intermediate film 12. For example, the conductor 40 includes an electric function portion including one or more electric heating wires or an electric heating layer, and can further include a feeding portion including a pair of feeding electrodes (a pair of busbars), as necessary. In FIG. 6, the same components as those in the first embodiment are denoted by the same reference numerals and characters, and the description thereof will be omitted.

For example, on the resin film 12F, one or more metal wires (for example, tungsten wires) are placed as one or more electric heating wires, and as necessary, a pair of metal foils (for example, copper foils) as a pair of feeding electrodes (busbars). Alternatively, on the resin film 12F, a resin film (for example, a polyethylene terephthalate (PET) film) may be placed, on the surface of which one or more electric heating wires and a pair of feeding electrodes are formed.

After the glass plate with the conductor 11Y is bonded with the glass plate 13 with the intermediate film 12 interposed therebetween, the electric function portion formed on the resin film 12F is connected to a conductor 20 consisting only of a feeding portion included in the glass plate with the conductor 11Y. The electric function portion formed on the resin film 12F may be connected to the conductor 20 consisting only of the feeding portion included in the glass plate with the conductor 11Y with a feeding portion formed on the resin film 12F interposed therebetween.

Note that the following can be designed as appropriate in the configuration, material, formation method, pattern, and formation region: the conductor 40, which is formed on the resin film 12F and includes an electric function portion and a feeding portion as necessary; and the conductor 20 consisting only of the feeding portion included in the glass plate with the conductor 11Y.

Also in this design modification example, as shown in FIG. 6, there can be implemented: manufacturing the laminated glass by bonding the glass plate with the conductor 11Y and the glass plate 13 with an intermediate film 12 interposed therebetween; then similarly to the first embodiment, a step (S5) of polishing the surface of the region including the terminal joint portion 20T of each feeding electrode 20B; and a step (S6) of joining the terminal 102 onto the polished surface of each feeding electrode 20B with the lead-free solder 101 interposed therebetween.

### Second Embodiment

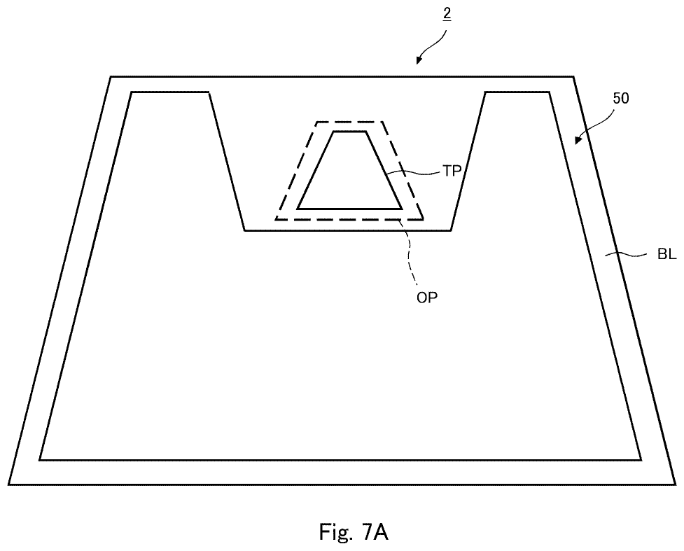

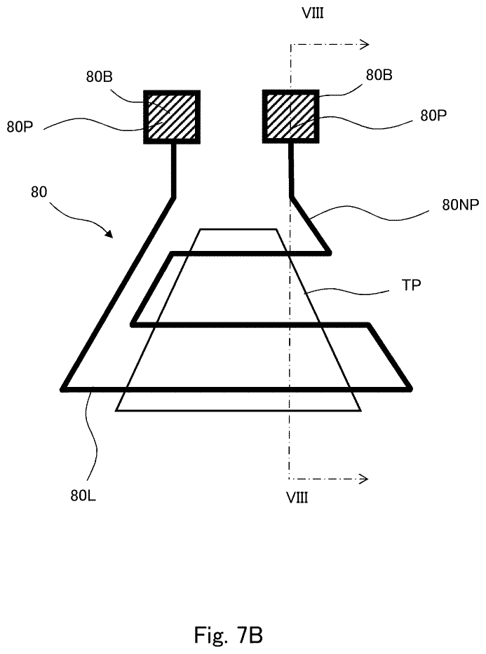

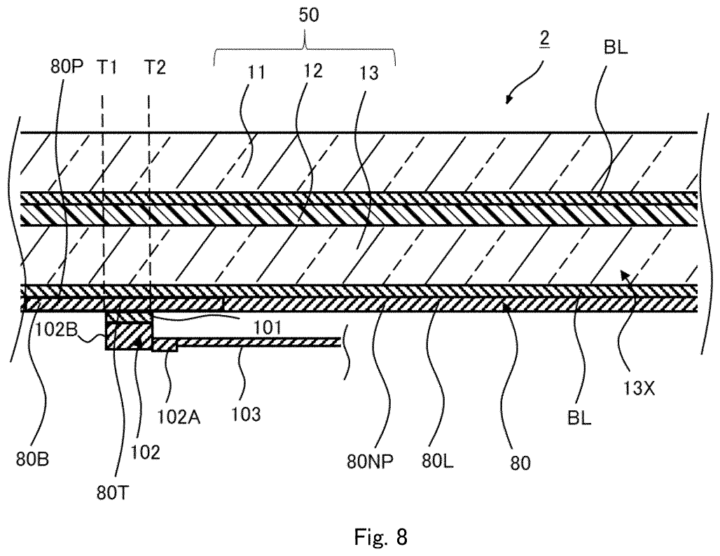

The structure of a windshield for vehicle according to a second embodiment of the present invention will be described with reference to the drawings. FIG. 7A is an overall plan view of the windshield for vehicle of this embodiment. FIG. 7B is a partially enlarged plan view of FIG. 7A. FIGS. 7A and 7B are diagrams before terminal joining. FIG. 8 is a cross-sectional view taken along a line VIII-VIII of FIG. 7B. In these figures, the plan view and the partially enlarged plan view are all perspective views. All of these figures are schematic diagrams, and for ease of visual recognition, the scale of each component is made different from the actual one as appropriate in each drawing. Components that are the same as those in the first embodiment are denoted by the same reference numerals and characters, and description thereof will be omitted.

As shown in FIG. 8, the windshield for vehicle 2 of this embodiment includes a laminated glass 50 in which a plurality of glass plates are bonded together with an intermediate film 12 interposed therebetween.

The laminated glass 50 includes: a glass plate with a terminal 13X that includes: a glass plate 13; a conductor 80 formed on one surface of the glass plate 13, made of a material containing silver and glass frit, and having a terminal joint portion 80T to which a terminal 102 is joined; and a terminal 102 joined onto the terminal joint portion 80T of the conductor 80 with lead-free solder 101 interposed therebetween.

In the illustrated example, the laminated glass 50 is a laminated glass in which a glass plate 11 and a glass plate with a terminal 13X are bonded together with an intermediate film 12 interposed therebetween. Similarly to the first embodiment, the glass plate 11 is the glass on the vehicle outer side, and the glass plate with the terminal 13X is the glass on the vehicle inner side. The laminated glass may be made by bonding three or more glass plates together.

As shown in FIG. 7A, the windshield for vehicle 2 includes: an optical apparatus mounting region OP where optical apparatuses are mounted; a light-transmitting portion TP located within the optical apparatus mounting region OP, through which light incident on the optical apparatuses from the outside and/or light emitted from the optical apparatuses pass; and a light-shielding layer BL. The light-shielding layer BL can contain a black pigment and glass frit.

As illustrated, the light-transmitting portion TP can be formed in a region relatively close to one end side (in the illustrated example, the upper end side) of the windshield for vehicle 2.

The formation region of the light-shielding layer BL can include: a region of the optical apparatus mounting region OP, excluding the light-transmitting portion TP; a region around the optical apparatus mounting region OP; and a peripheral region of the windshield for vehicle 2.

For autonomous driving and prevention of collision accidents, etc., for example, the optical apparatuses can include: optical devices such as ADAS (advanced driver assistance systems) cameras, LiDAR (light detection and ranging), a radar, and optical sensors that acquire information in front of the vehicle; and a housing called a bracket etc. that houses these.

The shapes of the optical apparatus mounting region OP and the light-transmitting portion TP can be appropriately designed depending on the shapes of the optical apparatuses, and examples include a substantially trapezoidal shape and a substantially rectangular shape. The shapes of the optical apparatus mounting region OP and the light-transmitting portion TP may be similar or dissimilar. In the illustrated example, the optical apparatus mounting region OP and the light-transmitting portion TP have a substantially trapezoidal shape.

In the illustrated example, the light-shielding layer BL surrounds all four sides of the light-transmitting portion TP. However, the light-shielding layer BL just needs to surround at least a part of the light-transmitting portion TP, and, for example, may surround only three sides of the substantially trapezoidal or substantially rectangular light-transmitting portion TP.

The wavelength range of light transmitted by the light-transmitting portion TP is not particularly limited, and includes, for example, the visible light range, the infrared light range, or the visible light range to infrared light range.

As shown in FIG. 7B, in this embodiment, the conductor 80 includes an electric function portion including one electric heating wire 80L or one electric heating layer. The conductor 80 further includes a feeding portion including a pair of feeding electrodes (a pair of busbars) 80B. Note that the conductor 80 may include a plurality of electric heating wires 80L. The configuration and pattern of the conductor 80 can be designed as appropriate.

The conductor 80 is preferably placed within the optical apparatus mounting region OP.

The conductor 80 may be formed on almost the entire surface of the windshield for vehicle 2.

The electric heating wire 80L or the electric heating layer for preventing fogging and frost is provided in the region including the light-transmitting portion TP located in front of the optical devices such as a camera and a radar included in the optical apparatus, thereby making it possible to improve the sensing accuracy of the optical apparatus.

The line pattern and arrangement pattern of the electric heating wires 80L are not particularly limited. For example, as shown in FIG. 7B, it is preferable that the electric heating wire 80L be bent so as to cross the light-transmitting portion TP a plurality of times in a plan view, thereby making it possible to efficiently remove frost and water droplets adhering to the light-transmitting portion TP.

The wire width of the electric heating wire 80L may change on the way from one feeding electrode to the other feeding electrode. In order to adjust the amount of heat generated by the electric heating wire 80L, the electric heating wire 80L may be arranged in regions other than the light-transmitting portion TP.

As shown in FIG. 8, in this embodiment, the conductor 80 is formed on the side opposite to the intermediate film 12 side with respect to the glass plate with the terminal 13X. Each of the pair of feeding electrodes (pair of busbars) 80B includes a terminal joint portion 80T, and the terminal 102 is joined onto the terminal joint portion 80T of the conductor 80 with lead-free solder 101 interposed therebetween. A feeding member 103 including a round-wire-shaped or foil-shaped conducting wire is fixed to each terminal 102.

Similarly to the first embodiment, the terminal joint portion 80T of the conductor 80 is a portion immediately underneath the lead-free solder 101. In the figure, the region of the terminal joint portion 80T is a region sandwiched between two broken lines T1 and T2. Note that the position of the terminal joint portion 80T of the conductor 80 is not clearly determined from the beginning. The terminal joint portion 80T is the portion immediately underneath the lead-free solder 101 after the terminal 102 is joined to the feeding electrode 80B with the lead-free solder 101 interposed therebetween.

In this embodiment, each power feeding electrode 80B has a polished surface of a region including the terminal joint portion 80T. In the examples shown in FIGS. 7B and 8, whole of each feeding electrode 80B is the polished portion 80P having the polished surface (that is, the feeding electrode 80B coincides with the polished portion 80P), and the electric heating wire 80L, which is the other part, is a non-polished portion 80NP having no polished surface. The region of the polished portion 80P may be smaller than the region of the feeding electrode 80B.

In the polished portion 80P of the conductor 80, the porosity is 10% or less, more preferably 8% or less, particularly preferably 7% or less, particularly preferably 3% or less. The lower limit of the porosity of the polished portion 80P of the conductor 80 is, for example, 0.5%.

The porosity of the non-polished portion 80NP of the conductor 80 is larger than the porosity of the polished portion 80P, and may be more than 10%, or 10% or less, and is for example 15 to 16%.

Since the breaking strength after terminal attachment can be effectively increased, the conductor 80 preferably satisfies at least one of the following conditions (Condition 2-1) to (Condition 2-3).
(Condition 2-1) The rate of the arithmetic mean surface roughness (Ra) of the polished portion 80P with respect to that of the non-polished portion 80NP is 5 to 80%.
(Condition 2-2) The reduction rate of film thickness of the polished portion 80P with respect to that of the non-polished portion 80NP is 4 to 40%.
(Condition 2-3) The rate of Bi/Ag mass ratio of the surface of the polished portion 80P with respect to that of the non-polished portion 80NP is 10 to 90%.

In condition 2-1, the rate of the arithmetic mean surface roughness (Ra) of the polished portion 80P with respect to that of the non-polished portion 80NP is more preferably 5 to 50%, particularly preferably 5 to 20%.

In condition 2-2, the reduction rate of the film thickness of the polished portion 80P with respect to that of the non-polished portion 80NP is more preferably 4 to 20%, particularly preferably 4 to 10%.

In condition 2-3, the rate of the Bi/Ag mass ratio of the surface of the polished portion 80P with respect to that of the non-polished portion 80NP is more preferably 10 to 50%, particularly preferably 10 to 20%.

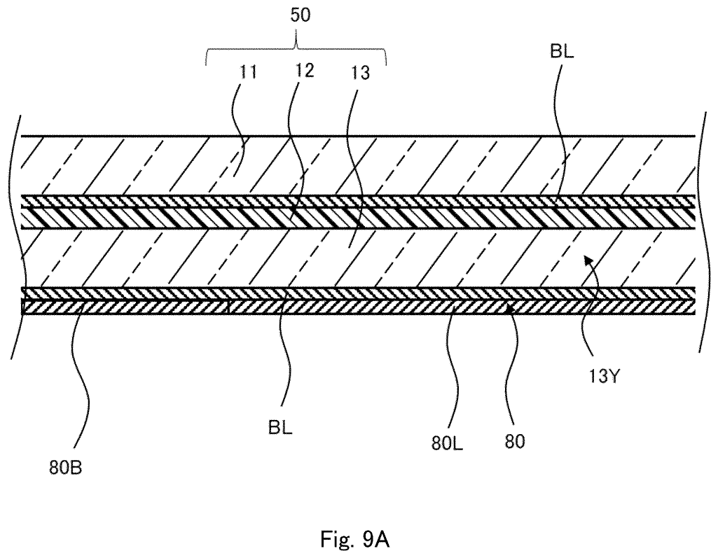

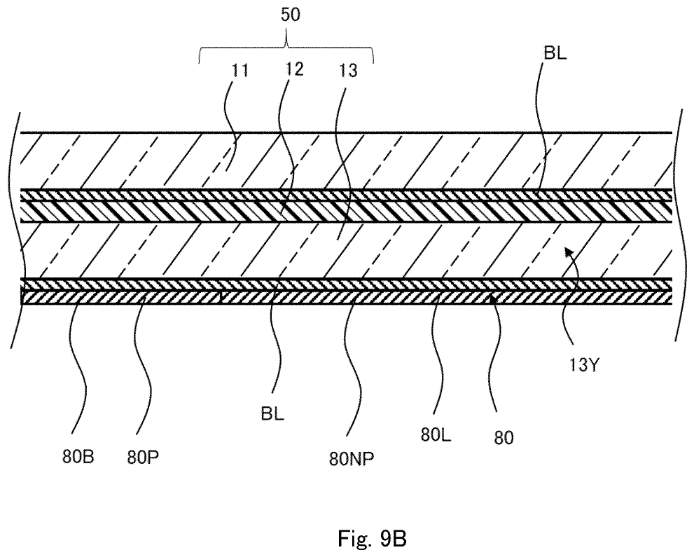

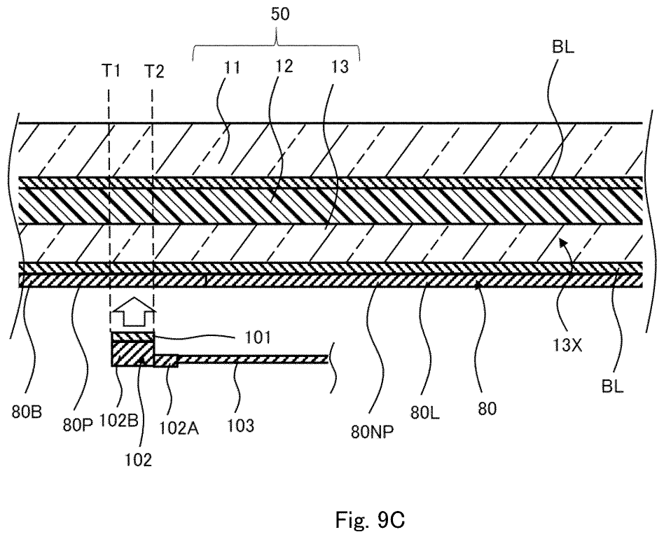

Each step of a method for manufacturing a windshield for vehicle according to this embodiment will be described with reference to the drawings. FIGS. 9A to 9C are schematic cross-sectional views corresponding to FIG. 8.

### (Step (S1))

First, similarly to the first embodiment, a ceramic paste containing a black pigment and glass frit, which are the materials of the light-shielding layer BL, is applied, as necessary, to one or more glass plates, which are the materials of laminated glass, and the paste is dried to form a ceramic paste layer. In this embodiment, a ceramic paste layer can be formed in a predetermined region of the glass plate 11 and/or the glass plate 13 that is the material of the glass plate with the terminal 13X.

### (Step (S2))

Similarly to the first embodiment, a silver-containing paste containing silver powder and glass frit is applied directly onto the glass plate 13 or onto the ceramic paste layer formed on the glass plate 13 as necessary, and the paste is dried to form a silver-containing paste layer.

### (Step (S3))

Next, similarly to the first embodiment, each glass plate is heated to a temperature of its softening point or above, and each glass plate is bent and formed. In this step, the silver-containing paste layer and the ceramic paste layer formed as necessary are simultaneously fired, and the light-shielding layer BL and the conductor 80 are formed. After firing, each glass plate is slowly cooled.

After these steps, there are obtained a glass plate 11 that may have a light-shielding layer BL; and a glass plate with a conductor 13Y that has a light-shielding layer BL on one surface of the glass plate 13 as necessary and has a conductor 80 formed directly on the glass plate 13 or on the light-shielding layer BL.

Next, similarly to the first embodiment, the outer glass plate 11, which may have the light-shielding layer BL, and the glass plate with the conductor 13Y are bonded together with the intermediate film 12 interposed therebetween, through a known method. After these steps, a laminated glass 50 shown in FIG. 9A is obtained.

### (Step (S5))

Next, the surface of the region including the terminal joint portion 80T of the conductor 80 is polished. The entire surface of each feeding electrode 80B may be polished, or the surface of a part of each feeding electrode 80B may be polished. After this step, as shown in FIGS. 7B and 9B, a laminated glass 50 is obtained that has a conductor 80 consisting of a polished portion 80P and a non-polished portion 80NP.

Note that in the conductor 80, the film thickness of the polished portion 80P becomes thinner than the film thickness of the non-polished portion 80NP due to polishing.

### (Step (S6))

Next, similarly to the first embodiment, as shown in FIG. 9C, the terminal 102 is joined onto the terminal joint portion 80T of the polished portion 80P included in each feeding electrode 80B with the lead-free solder 101 interposed therebetween. To the terminal 102, a feeding member 103 preferably including a round-wire-shaped or foil-shaped conducting wire is fixed (preferably fixed by caulking) in advance by a known method. For the solder jointing, see also FIG. 4.

In the manner described above, the windshield for vehicle 2 of this embodiment is manufactured.

Similarly to the first embodiment, the method for manufacturing a windshield for vehicle 2 according to this embodiment includes: a step (S5) of polishing the surface of the region including the terminal joint portion 80T of the conductor 80; and a step (S6) of joining the terminal 102 onto the terminal joint portion 80T, the surface of which has been polished, with lead-free solder 101 interposed therebetween. In this method, in the step (S5) (polishing step), it is possible to reduce the porosity of the terminal joint portion 80T of the conductor 80 and the amount of components of the glass frit on the surface of the terminal joint portion 80T of the conductor 80. This allows increase in the breaking strength after terminal attachment.

Since the breaking strength after terminal attachment can be effectively increased in the step (S5), polishing is preferably implemented so as to satisfy at least one of the following conditions (Condition 1-1) to (Condition 1-3).
(Condition 1-1) The rate of the arithmetic mean surface roughness (Ra) of the terminal joint portion 80T of the conductor 80 after polishing with respect that before polishing is 5 to 80%.
(Condition 1-2) The reduction rate of the film thickness of the terminal joint portion 80T of the conductor 80 after polishing with respect to that before polishing is 4 to 40%.
(Condition 1-3) The rate of Bi/Ag mass ratio of the surface of the terminal joint portion 80T of the conductor 80 after polishing with respect to that before polishing is 10 to 90%.

In Condition 1-1, the rate of the arithmetic mean surface roughness (Ra) of the terminal joint portion 80T of the conductor 80 after polishing with respect to that before polishing is more preferably 5 to 50%, particularly preferably 5 to 20%.

In Condition 1-2, the reduction rate of the film thickness of the terminal joint portion 80T of the conductor 80 after polishing with respect to that before polishing is more preferably 4 to 20%, particularly preferably 4 to 10%.

In Condition 1-3, the rate of Bi/Ag mass ratio of the surface of the terminal joint portion 80T of the conductor 80 after polishing with respect to that before polishing is more preferably 10 to 50%, particularly preferably 10 to 20%.

As described above, according to the present disclosure, a method for manufacturing a windshield for vehicle can be provided, the method including a step of soldering a conductor and a terminal together using lead-free solder and being able to increase breaking strength after terminal attachment.

According to the present disclosure, it is also possible to provide a windshield for vehicle that includes a portion where a conductor and a terminal are joined using lead-free solder and can have a higher breaking strength after terminal attachment.

### EXAMPLES

The present disclosure will be described below based on Examples, but the present disclosure is not limited thereto. Examples 12 to 17, 22 to 27, and 32 to 35 are examples, and Examples 11, 21, and 31 are comparative examples. In Examples 41 to 46, samples with polishing are examples, and samples without polishing are comparative examples.

### [Evaluation Items and Evaluation Methods]

The evaluation items and evaluation methods are as follows.

### (Porosity)

Application, firing, and polishing of a silver-containing paste was implemented on a glass plate that is the same as the glass plate used in each example, under the same conditions as those in each example, so that a glass plate with a conductor for evaluation (glass plate without a light-shielding layer for evaluation 1) was obtained. From this glass plate for evaluation, samples were cut out, each of which had a size that allowed easy observation of the terminal joint portion of the conductor.

The terminal joint portion of each of above samples was immersed in epoxy resin (“Aqra Type 53” manufactured by Sankei Co., Ltd) and cured at normal temperature, thereby embedding the terminal joint portion in the resin.

The terminal joint portion of the resin-embedded sample was cut in the thickness direction using a high-speed diamond wheel saw (“Mecatome T180” manufactured by Presi). The cut surface of the terminal joint portion was polished using an automatic polishing apparatus (“Mecatech 234” manufactured by Presi). Furthermore, as necessary, ion milling processing was performed using “ArBlade 5000” manufactured by Hitachi High-Tech Corporation.

Using a field emission scanning electron microscope (FE-SEM, “Regulus 8220” manufactured by Hitachi High-Tech Corporation), images of three randomly selected locations on the cut surface of the terminal joint portion were acquired at 2500 times magnification under the condition of a voltage of 3 kV. In the conductor in the cross-sectional SEM image, there were confirmed light gray regions each corresponding to a silver-containing region, dark gray regions each corresponding to glass frit-containing region, and black regions each corresponding to a vacancy. Image processing is implemented using commercially available image analysis software (“WinRooF 2018” manufactured by Mitani Corporation), and as the porosity of the conductor, the proportion of the cross-sectional area of the black regions corresponding to the vacancies with respect to the total cross-sectional area of the three regions was determined. The average value of the porosity of a total of three cross-sectional SEM images was determined and defined as data of the porosity (%).

### (Reduction Amount of Film Thickness)

A stylus-type measurement was implemented using a surface roughness meter (“Surfcom NEX 001” manufactured by Tokyo Seimitsu Co., Ltd.) to measure the reduction amount of film thickness of the conductor after polishing with respect to the thickness before polishing. Measurements were implemented a total of four times for each condition, and the average value thereof was defined as data of the reduction amount of film thickness.

### (Surface Roughness (Ra))

The arithmetic mean roughness (Ra) of the conductor before and after polishing were measured using a surface roughness meter (“Surfcom NEX 001” manufactured by Tokyo Seimitsu Co., Ltd.). Measurements were implemented three times in total for each condition, and the average value thereof was defined as data of the arithmetic mean roughness (Ra). Then, the rate (%) of the arithmetic mean surface roughness (Ra) of the conductor after polishing with respect to that of the conductor before polishing was determined.

### (SEM-EDX)

Using a field emission scanning electron microscope (FE-SEM, “Regulus 8220” manufactured by Hitachi High-Tech Corporation) as a SEM-EDX, energy dispersive X-ray (EDX) analysis of surface SEM images and cross-sectional SEM images were conducted.

EDX analysis was conducted on surface SEM images of the conductors before or after polishing.

EDX analysis of cross-sectional SEM images was conducted on the laminated structure of: a lead-free solder; a conductor before or after polishing; and a light-shielding layer.

In the surface SEM images and the cross-sectional SEM images, the distribution of the main metal elements is displayed in color with different colors each for individual metal elements. Voids were displayed in black.

Through EDX analysis of the surface SEM images, elemental analysis on each surface of conductor before or after polishing was conducted. The mass concentration of each main metal element on the surface of the conductor before or after polishing was determined, the mass ratio of each metal element to Ag was determined, and the Bi/Ag mass ratio was determined.

In addition, in the EDX analysis of the surface SEM images, in order to accurately calculate the mass concentration of P, SEM observation and EDX analysis were conducted after a small amount of Pt was vapor-deposited on the surface of the conductor. Note that in Table 3, data for Pt is excluded, so that the total mass concentration of each element in the table does not add up to 100%.

(Breaking Strength after Terminal Attachment)

A ring bending test was conducted in accordance with ASTM-C1499-1 using an Autograph (“AGS-X” manufactured by Shimadzu Corporation, maximum load: 5 kN) in an environment at normal temperature (20 to 25° C.).

The glass plates for evaluation 1 and 2 after terminal attachment were each placed on a support ring with a diameter of 98 mm with the surface on which the terminal was attached being facing downward. A load ring with a diameter of 46 mm was placed on this glass plate for evaluation. The central axis of the support ring, the central axis of the glass plate, and the central axis of the load ring were aligned.

A load was applied around the terminal of the glass plate for evaluation after terminal attachment, using a load ring. The load was continuously increased so that the amount of displacement of the glass plate was 1 mm/min, and the load at which the glass plate broke was defined as the breaking strength.

For each condition, a total of 5 samples were measured, and the average value thereof was defined as data of the breaking strength after terminal attachment.

### Examples 11-17, Examples 21-27

(Manufacture of Glass Plate with Conductor for Evaluation (Glass Plate for Evaluation 1))

A glass plate with a conductor for evaluation (glass plate without a light-shielding layer for evaluation 1) was manufactured in the same manner as described below [Manufacture of Glass Plate with Light-Shielding Layer and Conductor for Evaluation (Glass Plate for Evaluation 2)], except for directly formed a conductive paste layer on one surface of the glass plate without forming a ceramic paste layer.

(Manufacture of Glass Plate with Light-Shielding Layer and Conductor for Evaluation (Glass Plate for Evaluation 2)) A 100 mm×100 mm square, 2 mm thick, un-tempered glass plate (“VFL” manufactured by AGC) was prepared. A ceramic paste for forming a light-shielding layer containing a black pigment and glass frit was applied onto one surface of this glass plate, and dried to form a ceramic paste layer. The drying conditions were 120° C. for about 10 minutes. A ceramic paste A was used as the ceramic paste.

Next, a silver-containing paste for forming a conductor containing silver powder and glass frit was applied onto the ceramic paste layer, and dried to form a conductive paste layer. The drying conditions were 120° C. for about 10 minutes.

In Examples 11 to 17, a silver-containing paste A was used as the silver-containing paste.

In Examples 21 to 27, a silver-containing paste B was used as the silver-containing paste.

Each of the silver-containing pastes A and B had a vehicle content of 10 to 45% by mass.

Next, the ceramic paste layer and the conductive paste layer were fired. The layers were increased in temperature from normal temperature (20 to 25° C.) to 615° C. at a heating rate of about 180° C./min, fired at 615° C. for 3 minutes, and then naturally cooled to normal temperature (20 to 25° C.) (preliminary firing). The layers were then increased in temperature to 600° C. at a heating rate of about 180° C./min, fired at 600° C. for 3 minutes, and naturally cooled to normal temperature (20 to 25° C.) (main firing). In this way, a light-shielding layer and a conductor were formed.

The planar shape of the light-shielding layer was a square of 52 mm×52 mm, and its center and diagonal were aligned with the center and diagonal of the glass plate. The thickness of the light-shielding layer was about 15 μm.

The planar shape of the conductor was a square of 50 mm×50 mm, and its center and diagonal were aligned with the center and diagonal of the glass plate.

The thickness of the conductor formed using the silver-containing paste A was 8.2 μm.

The thickness of the conductor formed using the silver-containing paste B was 6.2 μm.

As described above, a glass plate with a light-shielding layer and a conductor for evaluation (glass plate for evaluation 2) was manufactured.

### (Polishing of Conductor)

In Examples 12 to 17 and Examples 22 to 27, the surface of each of the conductors of the glass plates for evaluation 1 and 2 was polished using a polishing eraser, metal fiber, or an electric-powered cutting tool (hand grinder). The following are the polishing conditions. The physical properties of the conductor were evaluated before and after polishing.

### <Polishing Eraser>

As the polishing eraser, “Sand Eraser for Ink and Ballpoint Pens” manufactured by SEED Co., Ltd. (grit number: #220 equivalent) was used. A polishing eraser was held by the fingers of one hand, and the eraser was moved horizontally from one end of the conductor to the other end with the eraser pressed against the surface of the conductor. This operation was implemented a total of 8 times.

### <Metal Fiber>

As the metal fiber, steel wool manufactured by Bonstar Co., Ltd. (grit number: #000, fiber center diameter: 14 μm, 1 g) was used.

The steel wool was held by the fingers of one hand, and the steel wool was moved horizontally from one end of the conductor to the other end with the steel wool pressed against the surface of the conductor. This operation was implemented totally 24 times of back-and-forth motion.

### <Electric-Powered Cutting Tool (Hand Grinder)>

As an electric-powered cutting tool (hand grinder), “Leutor (registered trademark)” manufactured by Nihon Seimitsu Kikai Kosaku Co., Ltd. was used. As each tip tool, an angle tool consisting of a combination of a rubber pad and a polishing disc attached to the rubber pad was used. Four types of polishing discs were used: cushion disc #1200, cushion disc #800, cushion disc #400, and cushion disc #240.

In the example in which the silver-containing paste A was used as the silver-containing paste, the rotational speed of the Leutor was 2000 rpm, and the polishing time was 10 seconds.

In the example in which the silver-containing paste B was used as the silver-containing paste, the rotational speed of the Leutor was 2000 rpm, and the polishing time was 5 seconds.

### <Solder Jointing>

In each example, a brass crimp terminal is joined onto the conductor of each of the glass plates for evaluation 1 and 2 using SnAg-based lead-free solder (Sn: 98% by mass, Ag: 2.0% by mass, melting point: about 220° C.). The brass crimp terminal includes: a tubular feeding member joint portion into which the head end portion (conductor-exposed portion) of the wire harness is inserted; and a bridge-shaped portion having solder joint portions at opposing ends as shown in FIG. 4.

The specific method is as follows.

An appropriate amount of lead-free solder was placed on the tip of a soldering iron and heated to melt. This solder is called preliminary solder.

A 0.05 g of lead-free solder chip was attached to each solder joint portion of the terminal. The terminal was placed on the terminal joint portions of the conductor. In this state, the tip of a soldering iron set at 300° C. was pressed against the solder joint portions of the terminal to heat and melt the lead-free solder chip. Thereafter, the soldering iron was removed from the terminal, and the lead-free solder was solidified by natural cooling.

After one hour elapsed from when the terminal was joined onto the conductor with lead-free solder interposed therebetween, the breaking strength of each of the glass plates for evaluation 1 and 2 after terminal attachment was measured.

### [Evaluation Results of Examples 11 to 17 and Examples 21 to 27]

Tables 1-1 and 1-2 show the main experimental conditions and evaluation results of Examples 11 to 17.

Tables 2-1 and 2-2 show the main experimental conditions and evaluation results of Examples 21 to 27.

TABLE 1-1

| | | | Breaking strength after | |
|---|---|---|---|---|
| | | | terminal attachment [MPa] | |
| | | | | Glass plate for |
| | | | Glass plate for | evaluation 2 |
| | | | evaluation 1 | Terminal/lead-free |
| | | | Terminal/lead-free | solder/conductor/ |
| | | | solder/conductor/ | light-shielding layer |
| | | | glass plate | (paste A)/glass plate |
| | | | firing temperature: | firing temperature: |
| | | | twice each at | twice each at |
| | Conductor | Polishing condition | 615° C. and 600° C. | 615° C. and 600° C. |
| Example 11 | Silver-containing | Without polishing | 37.9 | 28.7 |
| | paste A | | | |
| Example 12 | Silver-containing | Polishing eraser #220 | 61.1 | 49.3 |
| | paste A | | | |
| Example 13 | Silver-containing | Steel wool | 63.8 | 48.2 |
| | paste A | | | |
| Example 14 | Silver-containing | Leutor (cushion | 55.0 | 47.0 |
| | paste A | disc #1200) | | |
| Example 15 | Silver-containing | Leutor (cushion | 62.1 | 44.7 |
| | paste A | disc #800) | | |
| Example 16 | Silver-containing | Leutor (cushion | 68.1 | 42.2 |
| | paste A | disc #400) | | |
| Example 17 | Silver-containing | Leutor (cushion | 61.6 | 37.7 |
| | paste A | disc #240) | | |

TABLE 1-2

| | Conductor | | | | | | |
|---|---|---|---|---|---|---|---|
| | | | | Reduction amount of | | | |
| | | | | film thickness after | | | Rate of surface |
| | | | | polishing with respect to | | Surface | roughness Ra after |
| | | | | film thickness before | | roughness | polishing with respect to |
| | | | Porosity | polishing (8.2 μm) | | Ra | that before polishing |
| | Type | Polishing condition | [%] | [μm] | [%] | [μm] | [%] |
| Example 11 | Silver-containing paste A | Without polishing | 16.0 | 0 | 0.0 | 0.127 | 100.0 |
| Example 12 | Silver-containing paste A | Polishing eraser #220 | 1.6 | 1.2 | 14.6 | 0.119 | 93.8 |
| Example 13 | Silver-containing paste A | Steel wool | 2.3 | 1.4 | 17.1 | 0.073 | 57.5 |
| Example 14 | Silver-containing paste A | Leutor (cushion disc #1200) | 6.1 | 0.9 | 11.0 | 0.007 | 5.5 |
| Example 15 | Silver-containing paste A | Leutor (cushion disc #800) | 2.0 | 1.7 | 20.7 | 0.007 | 5.5 |
| Example 16 | Silver-containing paste A | Leutor (cushion disc #400) | 1.2 | 2.9 | 35.4 | 0.012 | 9.4 |
| Example 17 | Silver-containing paste A | Leutor (cushion disc #240) | 0.7 | 2.5 | 30.5 | 0.126 | 99.2 |

TABLE 2-1

| | | | Breaking strengh after | |
|---|---|---|---|---|
| | | | terminal attachment [MPa] | |
| | | | | Glass plate for |
| | | | Glass plate for | evaluation 2 |
| | | | evaluation 1 | Terminal/lead-free |
| | | | Terminal/lead-free | solder/conductor/ |
| | | | solder/conductor/ | light-shielding layer |
| | | | glass plate | (paste A)/glass plate |
| | | | firing temperature: | firing temperature: |
| | | | twice each at | twice each at |
| | Conductor | Polishing condition | 615° C. and 600° C. | 615° C. and 600° C. |
| Example 21 | Silver-containing | Without polishing | 29.6 | 23.0 |
| | paste B | | | |
| Example 22 | Silver-containing | Polishing eraser #220 | 56.1 | 41.2 |
| | paste B | | | |
| Example 23 | Silver-containing | Steel wool | 53.5 | 46.3 |
| | paste B | | | |
| Example 24 | Silver-containing | Leutor (cushion | 52.7 | 33.5 |
| | paste B | disc #1200) | | |
| Example 25 | Silver-containing | Leutor (cushion | 59.0 | 32.1 |
| | paste B | disc #800) | | |
| Example 26 | Silver-containing | Leutor (cushion | 62.4 | 39.8 |
| | paste B | disc #400) | | |
| Example 27 | Silver-containing | Leutor (cushion | 50.9 | 42.9 |
| | paste B | disc #240) | | |

TABLE 2-2

| | Conductor | | | | | | |
|---|---|---|---|---|---|---|---|
| | | | | Reduction amount of | | | |
| | | | | film thickness after | | | Rate of surface roughness |
| | | | | polishing with respect to | | | Ra after polishing with |
| | | | | film thickness before | | Surface | respect to that before |
| | | | Porosity | polishing (6.2 μm) | | roughness Ra | polishing |
| | Type | Polishing condition | [%] | [μm] | [%] | [μm] | [%] |
| Example 21 | Silver-containing paste B | Without polishing | 5.8 | 0 | 0.0 | 0.615 | 100.0 |
| Example 22 | Silver-containing paste B | Polishing eraser #220 | 3.1 | 0.85 | 13.7 | 0.337 | 54.8 |
| Example 23 | Silver-containing paste B | Steel wool | 4.7 | 0.27 | 4.4 | 0.397 | 64.6 |
| Example 24 | Silver-containing paste B | Leutor (cushion disc #1200) | 4.2 | 0.44 | 7.1 | 0.472 | 76.7 |
| Example 25 | Silver-containing paste B | Leutor (cushion disc #800) | 4.8 | 0.44 | 7.1 | 0.390 | 63.4 |
| Example 26 | Silver-containing paste B | Leutor (cushion disc #400) | 3.6 | 1.07 | 17.3 | 0.281 | 45.7 |
| Example 27 | Silver-containing paste B | Leutor (cushion disc #240) | 3.8 | 1.07 | 17.3 | 0.292 | 47.5 |

Comparison of Example 11 and Example 21 showed that under the same conditions except for the type of silver-containing paste, the conductor obtained using the silver-containing paste A had a smaller surface roughness (Ra) and a larger porosity than the conductor obtained using the silver-containing paste B when they are compared in an unpolished state.

The conductor of Example 11 obtained using the silver-containing paste A has a porosity of 16.0% in the unpolished state, and the porosity was comparable to the porosity of the conductive tracks of Examples 2 and 3 in [Examples] section of International Patent Publication No. WO 2017/098164.

The results of Examples 11 and 21 showed that under the same conditions except for the presence or absence of a light-shielding layer, the glass plate for evaluation 2 (with a light-shielding layer) had a lower breaking strength after terminal attachment than the glass plate for evaluation 1 (without a light-shielding layer) when they are compared in an unpolished state. It is presumed that under conditions with a light-shielding layer, a part of the components of the glass frit contained in the material for forming the light-shielding layer moves to the surface of the conductor in firing the paste, so that more components of the glass frit is present on the surface of the conductor, decreasing the joining strength between the conductor and solder.

Each of Examples 12 to 17 in which the surface of the conductor was polished had a lower porosity, film thickness, and arithmetic mean surface roughness (Ra) of the conductor than Example 11 in which the surface of the conductor was not polished.

Each of Examples 22 to 27 in which the surface of the conductor was polished had a lower porosity, film thickness, and arithmetic mean surface roughness (Ra) of the conductor than Example 21 in which the surface of the conductor was not polished.

Each of Examples 12 to 17 in which the surface of the conductor was polished successfully obtained a lower porosity of the conductor, which was 10% or less, than Example 11 in which the surface of the conductor was not polished. It is presumed that voids in the conductor are filled by polishing.

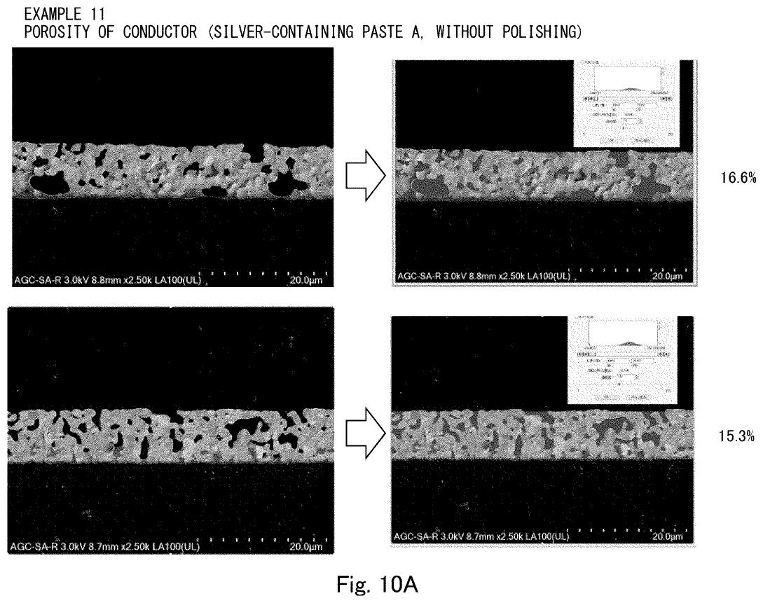

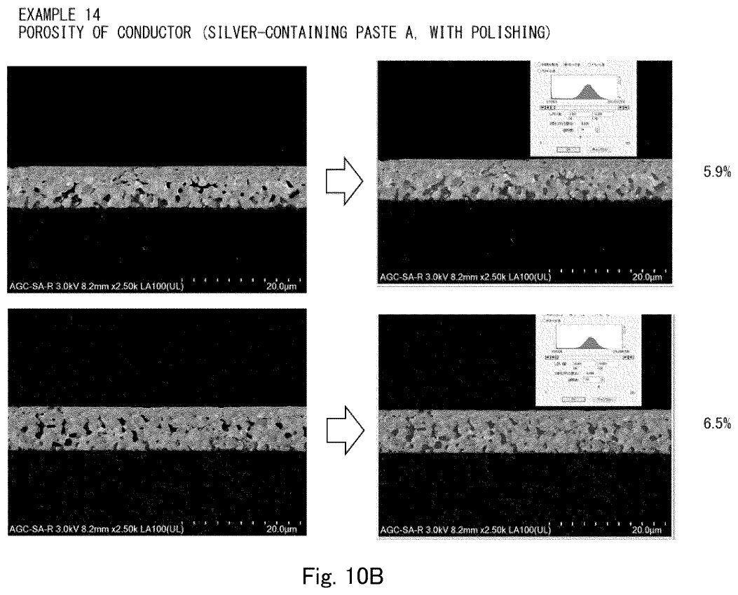

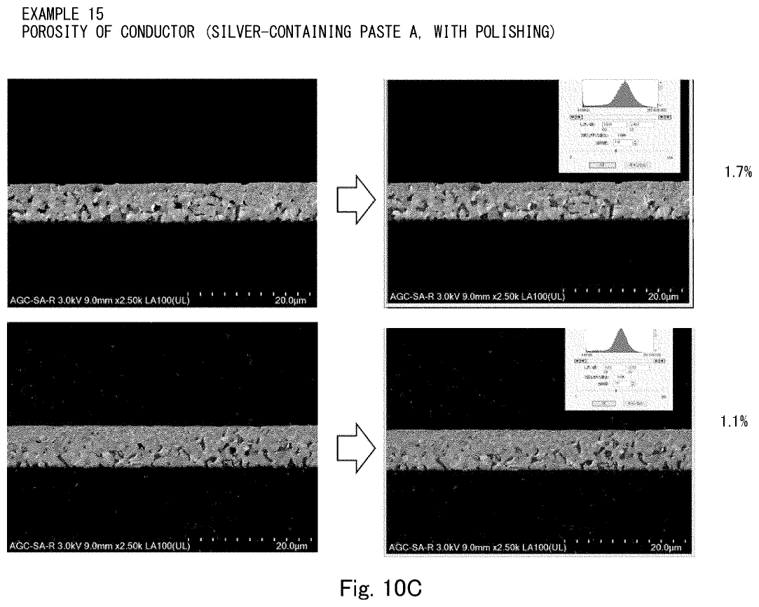

Examples of measuring porosity are shown in FIGS. 10A to 10C.

The two images on the left side of FIG. 10A show two cross-sectional SEM images of the three cross-sectional SEM images of the conductor obtained in Example 11, and the two images on the right side of FIG. 10A show the image processing and porosity measurement results of the two cross-sectional SEM images on the left side of the figure.

The two images on the left side of FIG. 10B show two cross-sectional SEM images of the three cross-sectional SEM images of the conductor obtained in Example 14, and the two images on the right side of FIG. 10B show the image processing and porosity measurement results of the two cross-sectional SEM images on the left side of the figure.

The two images on the left side of FIG. 10C show two cross-sectional SEM images of the three cross-sectional SEM images of the conductor obtained in Example 15, and the two images on the right side of FIG. 10C show the image processing and porosity measurement results of the two cross-sectional SEM images on the left side of the figure.

EDX analysis was conducted on the surface SEM images of the conductor before or after polishing, which were obtained in each example. EDX analysis of cross-sectional SEM images, which were obtained in each example, was conducted on each laminated structure of: a lead-free solder; a conductor before or after polishing; and a light-shielding layer.

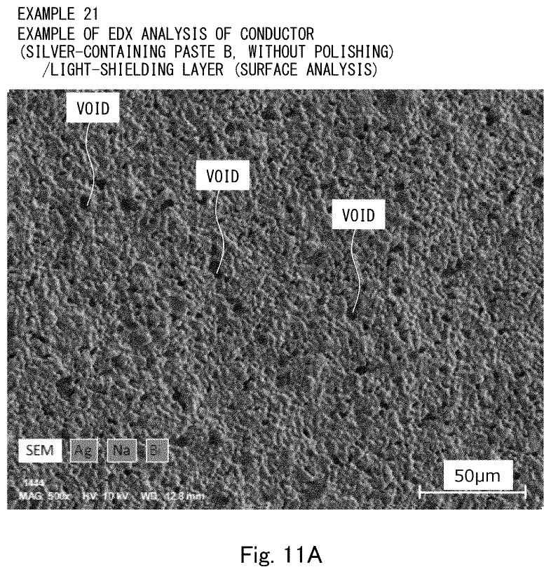

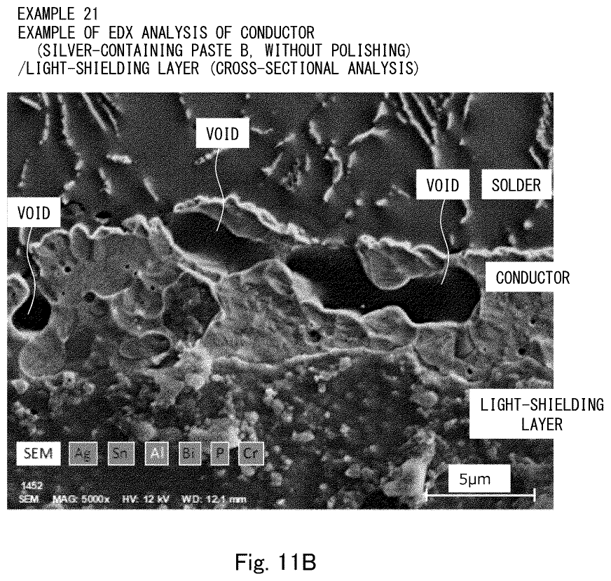

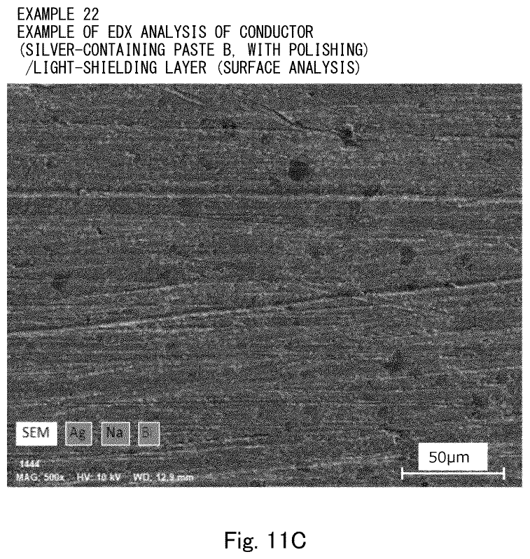

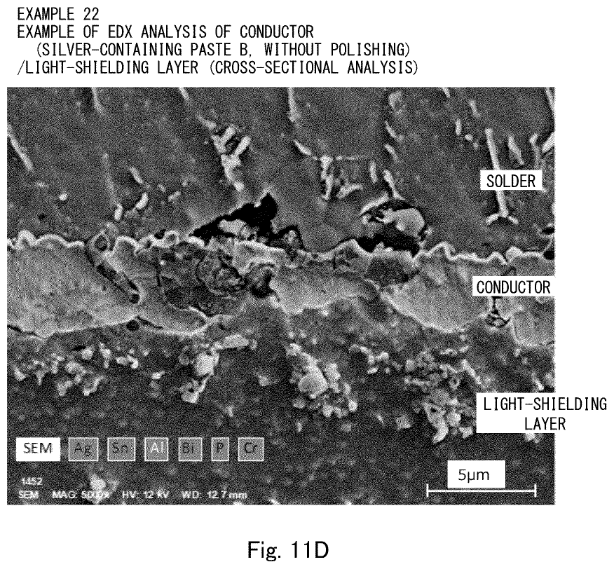

FIGS. 11A and 11B show an example of EDX analysis of the SEM images of the conductor obtained in Example 21 (without polishing, with light-shielding layer). FIG. 11A is a surface image, and FIG. 11B is a cross-sectional image.

FIGS. 11C and 11D show an example of EDX analysis of the SEM images of the conductor obtained in Example 22 (with polishing, with light-shielding layer). FIG. 11C is a surface image, and FIG. 11D is a cross-sectional image.

The surface images shown in FIGS. 11A and 11C are actually color images, with Ag shown in light blue, Na in orange, and Bi in pink.

The cross-sectional images shown in FIGS. 11B and 11D are actually color images, with Ag in pink, Sn in yellow, Al in dark blue, Bi in light blue, P in green, and Cr in red.

In the conductor obtained in Example 21 (without polishing, with a light-shielding layer), many large voids were observed both on the surface and in the cross section, whereas in the conductor obtained in Example 22 (with polishing, with a light-shielding layer), it was confirmed that voids disappeared or significantly reduced both on the surface and in the cross section. It is presumed that polishing the surface of the conductor stretches the silver to fill the voids.

In the conductor obtained in Example 21 (without polishing, with light-shielding layer), much Bi was found on the surface, whereas in the conductor obtained in Example 22 (with polishing, with light-shielding layer), it was confirmed that Bi on the surface reduced significantly. It is presumed that polishing the surface of the conductor removes components of the glass frit that are present in large quantities on the surface.

Energy dispersive X-ray (EDX) analysis of the surface SEM images was conducted and elemental analysis of the surface was conducted on the conductors obtained in Example 21 (without polishing, with light shielding layer) and Example 22 (with polishing, with light-shielding layer). The evaluation results are shown in Table 3.

TABLE 3

| | Example 21 (before polishing) | | Example 22 (after polishing) | | |
|---|---|---|---|---|---|
| | Conductor (silver-containing | | Conductor (silver-containing | | |
| | paste B)/light-shielding layer | | paste B)/light-shielding layer | | Rate of Bi/Ag mass |
| | (ceramic paste A)/glass plate | | (ceramic paste A)/glass plate | | ratio on surface |
| | Firing temperature: | | Firing temperature: | | of conductor |
| | twice respectively at | | twice respectively at | | after polishing |
| Metal element | 615° C. and 600° C. | | 615° C. and 600° C. | | with respect to that |
| on conductor | Mass concentration | Mass ratio to Ag | Mass concentration | Mass ratio to Ag | before polishing |
| surface | [% by mass] | [—] | [% by mass] | [—] | [%] |
| Na | 1.88 | 0.021 | 0.64 | 0.007 | — |
| Al | 0.30 | 0.003 | 0.20 | 0.002 | — |
| Si | 0.48 | 0.005 | 0.29 | 0.003 | — |
| P | 0.72 | 0.008 | 0.51 | 0.005 | — |
| Zn | 0.34 | 0.004 | 0.35 | 0.004 | — |
| Ag | 91.65 | 1.000 | 96.03 | 1.000 | — |
| Ba | 0.55 | 0.006 | 0.41 | 0.004 | — |
| Bi | 3.03 | 0.033 | 1.00 | 0.010 | 31.50 |

In the example shown in Table 3, the Bi/Ag mass ratio after polishing decreased with respect to that before polishing, and it was confirmed that polishing reduced the amount of glass frit components present on the surface of the conductor. The rate of the Bi/Ag mass ratio of the conductor after polishing with respect to that before polishing was 31.50%, which was about ⅓.

Examples 12 to 17, in each of which the surface of the conductor was polished, satisfied the following conditions (Condition 1-1) to (Condition 1-3), and each had an improved breaking strength after terminal attachment relative to Example 11 in both of the glass plate for evaluation 1 (without a light-shielding layer) and the glass plate for evaluation 2 (with a light-shielding layer).

Examples 22 to 27, in each of which the surface of the conductor was polished, satisfied the following conditions (Condition 1-1) to (Condition 1-3), and each had an improved breaking strength after terminal attachment relative to Example 21 in both of the glass plate for evaluation 1 (without a light-shielding layer) and the glass plate for evaluation 2 (with a light-shielding layer).
(Condition 1-1) The rate of the arithmetic mean surface roughness (Ra) of the terminal joint portion of the conductor after polishing with respect to that of the terminal joint portion before polishing is 5 to 80%.
(Condition 1-2) The reduction rate of the film thickness of the terminal joint portion of the conductor after polishing with respect to the film thickness before polishing is 4 to 40%.
(Condition 1-3) The rate of Bi/Ag mass ratio of the terminal joint portion of the conductor after polishing with respect to that before polishing is 10 to 90%.

### Examples 31 to 35

In Example 31, the glass plate with a light-shielding layer and a conductor for evaluation (glass plate for evaluation 2, conductor (without polishing)/light-shielding layer/glass plate) was manufactured in the same manner as Example 21 except for changing the type of ceramic paste for forming the light-shielding layer.

In Example 32, the glass plate with a light-shielding layer and a conductor for evaluation (glass plate for evaluation 2, conductor (with polishing)/light-shielding layer/glass plate) was manufactured in the same manner as Example 22 except for changing the type of ceramic paste for forming the light-shielding layer.

In each of Examples 33 to 35, the glass plate with a light-shielding layer and a conductor for evaluation (glass plate for evaluation 2, conductor (with polishing)/light-shielding layer/glass plate) was manufactured in the same manner as Example 32 except for changing the grit number of polishing eraser.

In these examples, a ceramic paste B was used as the ceramic paste for forming the light-shielding layer.

The polishing erasers used in each of Examples 32 to 35 are as follows.
Example 32: “rust eraser “SK-11 ” manufactured by Fujiwara Sangyo Co., Ltd. (grit number: #220),
Example 33: “Sabitol” manufactured by Chukyokenma Co., Ltd. (grit number: #320),
Example 34: “Stella Block” manufactured by Okasugi Co., Ltd. (grit number: #500),
Example 35: “rust eraser “SK-11” manufactured by Fujiwara Sangyo Co., Ltd. (grit number: #1000).

The conductors obtained in each of Examples 31 to 35 were subjected to solder joining in the same manner as in Examples 21 and 22, and the breaking strength of the glass plate for evaluation 2 after terminal attachment was measured. Table 4 shows the main experimental conditions and evaluation results of Examples 31 to 35.

In each of Examples 32 to 35 in which the surface of the conductor was polished, the breaking strength after terminal attachment was improved relative to Example 31 in which the surface of the conductor was not polished.

TABLE 4

| | | | Breaking strength after |
|---|---|---|---|
| | | | terminal attachment [MPa] |
| | | | Glass plate for evaluation 2 |
| | | | Terminal/lead-free solder/ |
| | | | conductor/light-shielding |
| | | | layer (paste B)/glass plate |
| | Conductor | Polishing condition | firing temperature: 630° C. |
| Example 31 | Silver-containing paste B | Without polishing | 55.6 |
| Example 32 | Silver-containing paste B | Polishing eraser #220 | 73.0 |
| Example 33 | Silver-containing paste B | Polishing eraser #320 | 82.5 |
| Example 34 | Silver-containing paste B | Polishing eraser #500 | 76.9 |
| Example 35 | Silver-containing paste B | Polishing eraser #1000 | 73.2 |

### Examples 41 to 46

In Examples 41 to 46, the glass plate with a light-shielding layer and a conductor for evaluation (glass plate for evaluation 2, conductor (without polishing)/light-shielding layer/glass plate) was manufactured in the same manner as Example 21 except for changing the type of ceramic paste for forming the light-shielding layer and the firing temperature of the ceramic paste layer and the conductive paste layer.

In Examples 41 to 46, the glass plate with a light-shielding layer and a conductor for evaluation (glass plate for evaluation 2, conductor (with polishing)/light-shielding layer/glass plate) was manufactured in the same manner as Example 22 except for changing the type of ceramic paste for forming the light-shielding layer and the firing temperature of the ceramic paste layer and the conductive paste layer.

The ceramic paste layer and the conductive paste layer were heated from normal temperature (20 to 25° C.) to the desired firing temperature at a heating rate of about 180° C./min, were fired at this temperature for about 3 minutes, and then naturally cooled to normal temperature (20 to 25° C.).

The firing temperature were set to 10 conditions within the range of 590° C. to 680° C.

The ceramic paste for forming the light-shielding layer used in each example is as follows:
Example 41: Ceramic paste B,
Example 42: Ceramic paste C,
Example 43: Ceramic paste D,
Example 44: Ceramic paste E,
Example 45: Ceramic paste F, and
Example 46: Ceramic paste G.

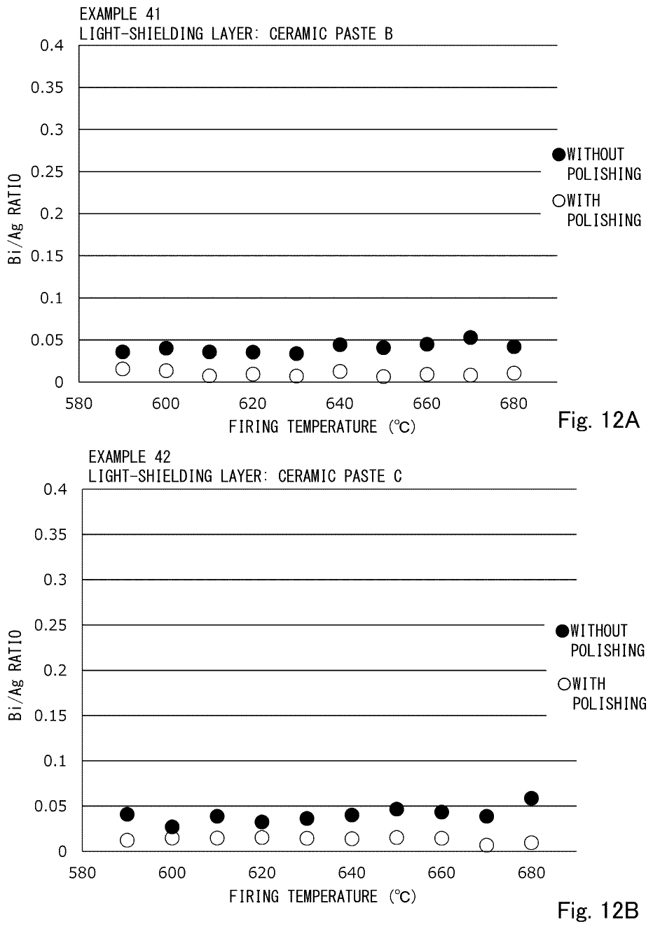

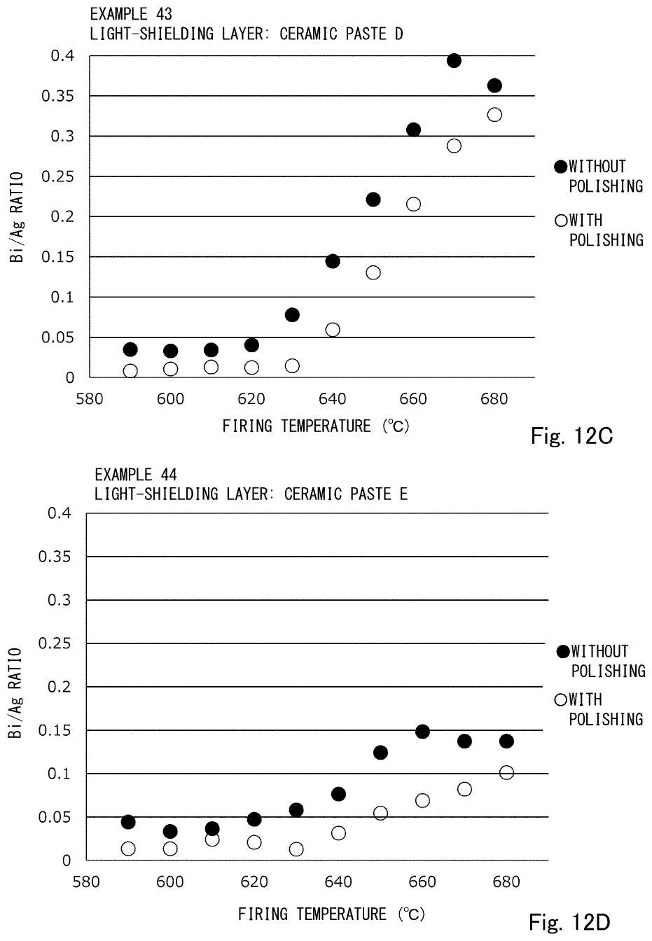

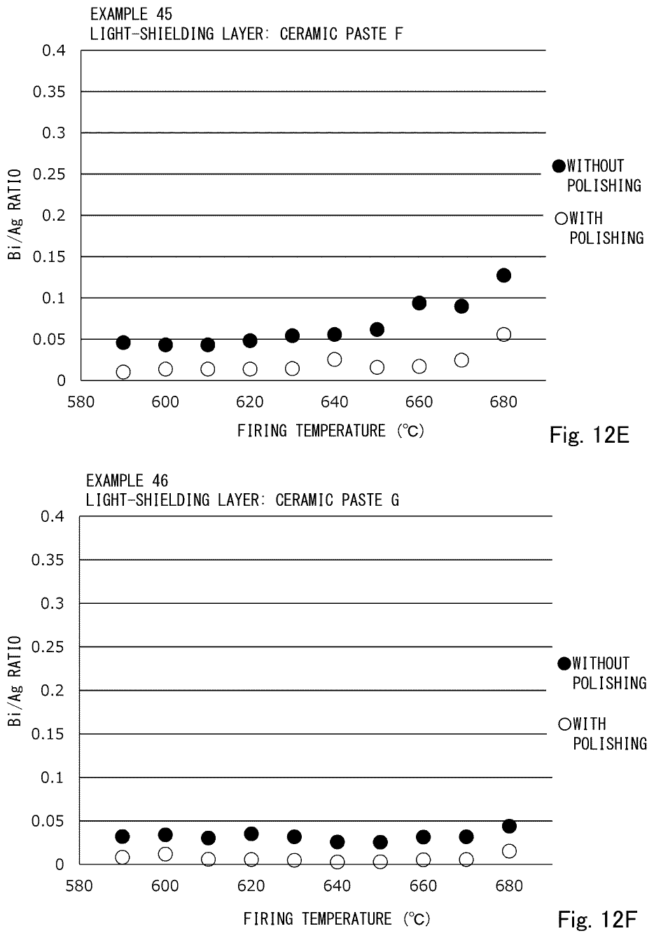

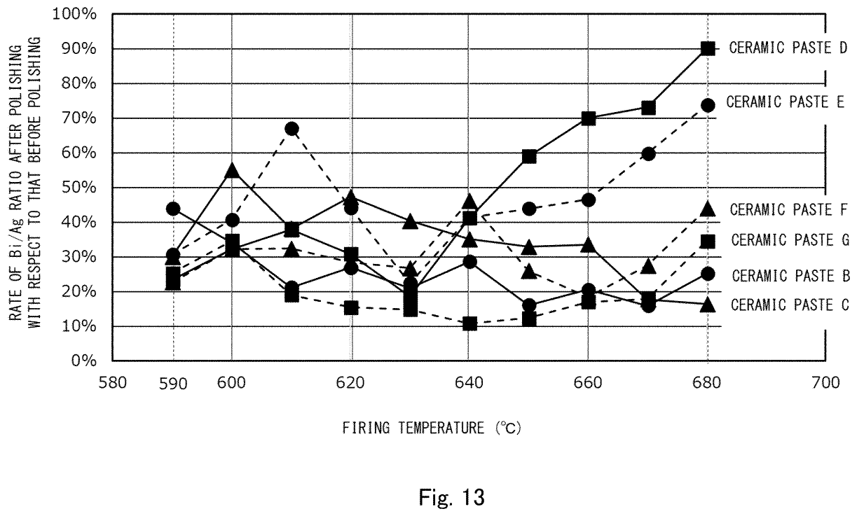

Energy dispersive X-ray (EDX) analysis of the surface SEM images was conducted and elemental analysis of the surface was conducted on each conductor obtained in each example, in the same manner as in Example 21 and Example 22. The Bi/Ag mass ratio on the surface of the conductor was determined each for before and after polishing, and the rate of the Bi/Ag mass ratio on the surface of the conductor after polishing with respect to that before polishing was determined. The evaluation results are shown in FIGS. 12A to 12F and FIG. 13.

In any of the examples shown in FIGS. 12A to 12F and 13, the rate of the Bi/Ag mass ratio of the surface of the conductor after polishing with respect to that before polishing was 10 to 90%. Many of the examples shown in FIG. 13 each had a rate of the Bi/Ag mass ratio of the surface of the conductor after polishing with respect to that before polishing of 10 to 70%. Many of the examples shown in FIG. 13 each had a rate of the Bi/Ag mass ratio of the surface of the conductor after polishing with respect to that before polishing of 10 to 50%.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

The first and second embodiments can be combined as desirable by one of ordinary skill in the art.

What is claimed is:

1. A method for manufacturing a windshield for vehicle, the windshield for vehicle including a laminated glass in which a plurality of glass plates are bonded together with an intermediate film interposed therebetween,
the laminated glass including a glass plate with a terminal, the glass plate with the terminal including a glass plate of the plurality of glass plates, a conductor, and the terminal, the conductor being formed on one surface of the glass plate, the conductor including a material containing silver and glass frit, the conductor having a terminal joint portion to which the terminal is joined, the terminal being joined onto the terminal joint portion of the conductor with lead-free solder interposed therebetween, the method comprising:
a step (S2) of applying a silver-containing paste containing silver and glass frit, which are materials of the conductor, onto the glass plate, which is a material of the glass plate with the terminal;
a step (S3) of firing the glass plate coated with the materials of the conductor to form the conductor including the terminal joint portion;
a step (S5) of polishing a surface of a region including the terminal joint portion of the conductor; and
a step (S6) of joining the terminal onto the terminal joint portion, a surface of which has been polished, with lead-free solder interposed therebetween,
wherein a porosity of the terminal joint portion of the conductor after the step (S5) is 10% or less.

2. The method for manufacturing a windshield for vehicle according to claim 1, wherein in the step (S2), a content of a vehicle in the silver-containing paste is 10 to 45% by mass.

3. The method for manufacturing a windshield for vehicle according to claim 1, wherein in the step (S5), a rate of an arithmetic mean surface roughness of the terminal joint portion of the conductor after polishing with respect to that before polishing is 5 to 80%.

4. The method for manufacturing a windshield for vehicle according to claim 1, wherein in the step (S5), a reduction rate of a film thickness of the terminal joint portion of the conductor after polishing with respect to that before polishing is 4 to 40%.

5. The method for manufacturing a windshield for vehicle according to claim 1, wherein in the step (S5), a rate of Bi/Ag mass ratio of a surface of the terminal joint portion of the conductor after polishing with respect to that before polishing is 10 to 90%.

6. The method for manufacturing a windshield for vehicle according to claim 1, wherein
in the laminated glass, the glass plate with the terminal includes an exposed portion not covered by the glass plate facing the glass plate with the terminal with the intermediate film interposed therebetween, the conductor is formed on a side of the intermediate film with respect to the glass plate with the terminal, and the terminal joint portion of the conductor is formed on the exposed portion of the glass plate with the terminal, and
the method includes, between the step (S3) and the step (S5), a step (S4) of bonding the plurality of glass plates with the intermediate film interposed therebetween.

7. The method for manufacturing a windshield for vehicle according to claim 1, wherein
in the laminated glass, the conductor is formed on a side opposite to the intermediate film with respect to the glass plate with the terminal, and
the method includes, between the step (S3) and the step (S5), a step (S4) of bonding the plurality of glass plates with the intermediate film interposed therebetween.

8. The method for manufacturing a windshield for vehicle according to claim 1, wherein
the glass plate with the terminal has a light-shielding layer between the glass plate and the terminal joint portion of the conductor,
the method includes, before the step (S2), a step (S1) of applying a ceramic paste containing a black pigment and glass frit, which are materials of the light-shielding layer, onto the glass plate, which is the material of the glass plate with the terminal, and
in step (S3), the materials of the light-shielding layer are fired to form the light-shielding layer.

9. The method for manufacturing a windshield for vehicle according to claim 1, wherein
the conductor includes an electric function portion or is electrically connected to an electric function portion,
the conductor includes a feeding portion for feeding electricity to the electric function portion, and the feeding portion includes the terminal joint portion, and
a feeding member including a round-wire-shaped or foil-shaped conducting wire is fixed to the terminal.

10. A windshield for vehicle comprising a laminated glass in which a plurality of glass plates are bonded together with an intermediate film interposed therebetween,
the laminated glass including a glass plate with a terminal, the glass plate with the terminal including a glass plate of the plurality of glass plates, a conductor, and the terminal, the conductor being formed on one surface of the glass plate, the conductor including a material containing silver and glass frit, the conductor having a terminal joint portion to which the terminal is joined, the terminal being joined onto the terminal joint portion of the conductor with lead-free solder interposed therebetween,
wherein the conductor includes a polished surface in a region including the terminal joint portion, and includes a polished portion with a porosity of 10% or less.

11. The windshield for vehicle according to claim 10, wherein
the conductor includes a non-polished portion that does not have a polished surface in a region that does not include the terminal joint portion, and
a rate of an arithmetic mean surface roughness of the polished portion with respect to that of the non-polished portion is 5 to 80%.

12. The windshield for vehicle according to claim 10, wherein
the conductor includes a non-polished portion that does not have a polished surface in a region that does not include the terminal joint portion, and
a reduction rate of a film thickness of the polished portion with respect to that of the non-polished portion is 4 to 40%.

13. The windshield for vehicle according to claim 10, wherein
the conductor includes a non-polished portion that does not have a polished surface in a region that does not include the terminal joint portion, and
a rate of a Bi/Ag mass ratio of a surface of the polished portion with respect to that of the non-polished portion is 10 to 90%.

14. The windshield for vehicle according to claim 10, wherein
the glass plate with the terminal includes a light-shielding layer between the glass plate and the terminal joint portion of the conductor, and
the light-shielding layer contains a black pigment and glass frit.

15. The windshield for vehicle according to claim 10, wherein
the conductor includes an electric function portion or is electrically connected to an electric function portion,
the conductor includes a feeding portion for feeding electricity to the electric function portion, and the feeding portion includes the terminal joint portion, and
a feeding member including a round-wire-shaped or foil-shaped conducting wire is fixed to the terminal.
